(19) United States
(12) Patent Application Publication
(10) Pub. No.: US 2014/0207932 A1
(43) Pub. Date: Jul. 24, 2014

(54) INFORMATION PROCESSING SYSTEM AND INFORMATION PROCESSING METHOD

(71) Applicant: Kiyohiro HYO, Tokyo (JP)

(72) Inventor: Kiyohiro HYO, Tokyo (JP)

(73) Assignee: RICOH COMPANY, LTD., Tokyo (JP)

(21) Appl. No.: 14/160,689

(22) Filed: Jan. 22, 2014

(30) Foreign Application Priority Data
Jan. 24, 2013 (JP) 2013-010822
Nov. 29, 2013 (JP) 2013-246954

(51) Int. Cl. H04L 12/24

(52) U.S. Cl. CPC H04L 41/24
USPC 709/223

(57) ABSTRACT

An information processing system including at least one computer includes a first assigning part that receives from a device a process request including device process identification information identifying a predetermined process unit of the device and assigns request identification information identifying the process request; and a storage part that stores the device process identification information and the request identification information in association with each other in connection with a process executed in response to the process request.

### CROSS-REFERENCE TO RELATED APPLICATIONS

This application is based on and claims the benefit of priority of Japanese Patent Application No. 2013-010822 filed on Jan. 24, 2013, and Japanese Patent Application No. 2013-246954 filed on Nov. 29, 2013, the entire contents of which are incorporated herein by reference.

### BACKGROUND OF THE INVENTION

1. Field of the Invention

The disclosures herein generally relate to an information processing system and an information processing method.

2. Description of the Related Art

There are services that are provided by having a device such as an image forming apparatus cooperate with a computer that is connected to the device via a LAN (local area network) or a WAN (wide area network), such a computer simply being referred to as “server” hereinafter. For example, a service may involve having an image forming apparatus scan image data of a document and transfer the image data to a server, and having the server perform an image process on the image data or store the image data in a predetermined storage.

When an error occurs in a service provided through cooperation of a device and a server as described above, it may be difficult to determine the correspondence between a process executed at the device and a process executed at the server that are associated with the same service. Generally, logs are individually recorded at the server and the device. Thus, a correspondence between a process at the device side and a process at the server side may be determined by referring to their logs to find matching logs (see e.g., Japanese Laid-Open Patent Publication No. 2010-161714; Japanese Laid-Open Patent Publication No. 2008-129955; Japanese Laid-Open Patent Publication No. 2012-084041).

However, to match up the logs of the device and the server, the timing of the processes have to be accurately determined. As one way of determining the timing of the processes of the device and the server, time information may be used, for example. That is, the correspondence between a process of the device and a process of the server may be determined based on time information of the logs related to the above processes that are maintained at the device side and the server side, respectively.

However, when time information is used to determine the correspondence between a process of the device and a process of the server, system time information at the device side and system time information at the server side have to match. Also, even if the system time information at the device side and the system time information at the server side match, messages transferred between the device and the server may be delayed, and a start time of a process to be executed by the server in response to a request from the device may be unstable. Further, a server may cooperate with a plurality of devices, and the server may execute a plurality of processes in parallel in response to receiving requests from a plurality of devices.

Thus, determining a correspondence between a process of a device and a process of a server based on time information may actually be quite difficult.

Accordingly, there is a demand for a technique that can facilitate the determination of a correspondence between processes that are executed over a network.

### SUMMARY OF THE INVENTION

According to one embodiment of the present invention, an information processing system with at least one computer includes a first assigning part that receives from a device a process request including device process identification information identifying a predetermined process unit of the device and assigns request identification information identifying the process request, and a storage part that stores the device process identification information and the request identification information in association with each other in connection with a process executed in response to the process request.

According to an aspect of the present invention, determination of a correspondence between processes executed over a network may be facilitated.

### BRIEF DESCRIPTION OF THE DRAWINGS

FIG. 1 illustrates a relationship between a device and a cloud service system according to a first embodiment of the present invention;

FIG. 2 illustrates an exemplary functional configuration of the cloud service system according to the first embodiment;

FIG. 3 illustrates an exemplary network configuration of the cloud service system according to the first embodiment;

FIG. 4 illustrates an exemplary hardware configuration of a computer included in the cloud service system according to the first embodiment;

FIG. 5 illustrates an exemplary software configuration of an image forming apparatus used in the first embodiment;

FIG. 6 is a sequence chart illustrating process steps of a log recording process implemented in a cloud service system;

FIG. 7 illustrates an exemplary message including a request from the image forming apparatus;

FIG. 8 illustrates an exemplary message having a request ID included therein;

FIG. 9 illustrates an exemplary message having a unique ID included therein;

FIG. 10 illustrates an exemplary server log related to an authentication process;

FIG. 11 illustrates an exemplary server log related to content processing;

FIG. 12 illustrates an exemplary server log related to a process executed by a print application;

FIG. 13 illustrates an exemplary configuration of a device log storage part;

FIG. 14 is a sequence chart illustrating exemplary process steps of a device log uploading process;

FIG. 15 illustrates an exemplary message including a device log uploading request;

FIG. 16 illustrates an exemplary display of a log browsing screen;

FIG. 17 is a flowchart illustrating exemplary process steps that are executed by a gateway upon receiving a message in a second embodiment of the present invention;

FIG. 18 is a flowchart illustrating exemplary process steps that are executed by a server upon receiving a message in the second embodiment;

FIG. 19 illustrates an exemplary functional configuration of a cloud service system according to a third embodiment of the present invention;

FIG. 20 illustrates an exemplary network configuration of the cloud service system according to the third embodiment;

FIG. 21 is a sequence chart illustrating exemplary process steps that are executed in connection with an asynchronous process in the third embodiment;

FIG. 22 illustrates exemplary server logs that are recorded in the third embodiment;

FIG. 23 illustrates an exemplary functional configuration of a cloud service system according to a fourth embodiment of the present invention;

FIG. 24 illustrates an exemplary network configuration of the cloud service system according to the fourth embodiment;

FIG. 25 is a sequence chart illustrating exemplary process steps that are executed in response to a call for a log utilizing API;

FIG. 26 illustrates an exemplary server log including device type information;

FIG. 27 illustrates a first example of a return value provided by a getClientReport method;

FIG. 28 illustrates a first example of information indicating a count result of logs searched in connection with implementing the getClientReport method;

FIG. 29 illustrates a second example of a return value provided by the getClientReport method;

FIG. 30 illustrates a second example of information indicating a count result of logs searched in connection with implementing the getClientReport method;

FIG. 31 illustrates a first example of a return value provided by a getJobReport method;

FIG. 32 illustrates a second example of a return value provided by the getJobReport method;

FIG. 33 illustrates an exemplary server log including information on a delivery destination and a content format;

FIG. 34 illustrates a first example of a return value provided by a getErrorReport method;

FIG. 35 illustrates a second example of a return value provided by the getErrorReport method;

FIG. 36 is a sequence chart illustrating exemplary process steps that are executed in response to a call for the getCustomerReport method;

FIG. 37 illustrates a first example of a return value provided by a getCustomerReport method;

FIG. 38 illustrates a second example of a return value provided by the getCustomerReport method; and

FIG. 39 is a sequence chart illustrating exemplary process steps of an application ID assigning process.

### DESCRIPTION OF THE PREFERRED EMBODIMENTS

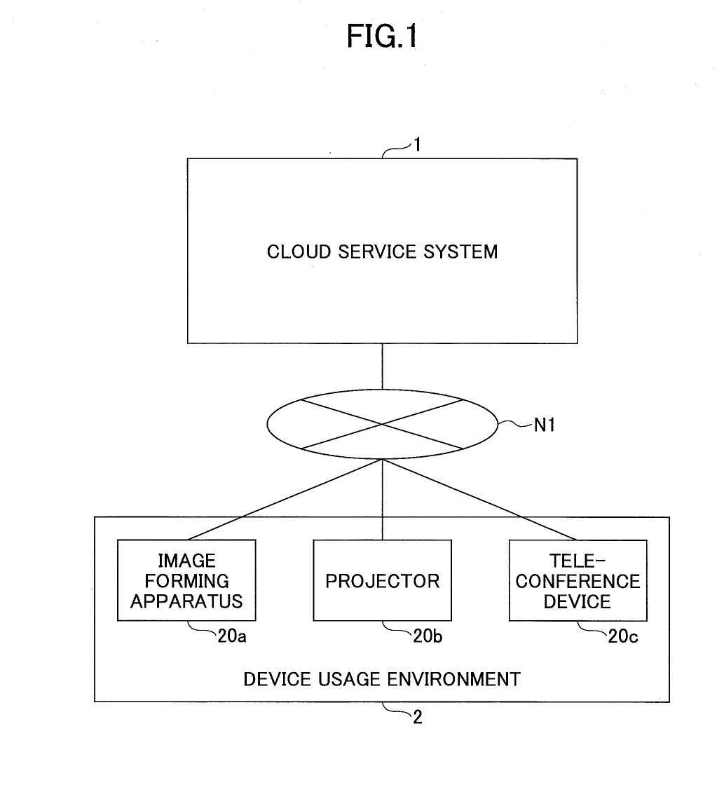

In the following, embodiments of the present invention are described with reference to the accompanying drawings. FIG. 1 illustrates a relationship between a device and a cloud service system according to a first embodiment of the present invention. In FIG. 1, a cloud service system 1 and devices 20 within a device usage environment 2 are connected via a network N1, which may be a wide area network (WAN) such as the Internet.

The device usage environment 2 is an environment where devices 20 that are capable of cooperating with a service provided by the cloud service system 1 are used. For example, the device usage environment 2 may correspond to an office of a company. In FIG. 1, an image forming apparatus 20a, a projector 20b, and a teleconference device 20c are illustrated as examples of the devices 20.

The image forming apparatus 20a may be a multifunction peripheral (MFP), a printer, a scanner, or a facsimile machine, for example. The projector 20b is a device that projects image data. The teleconference device 20c is a device used to conduct a teleconference. Note that aspects of the present embodiment may be applied to devices other than those illustrated above.

The cloud service system 1 includes at least one computer and is configured to provide various services through cooperation with the device 20. For example, as a service provided in cooperation with the image forming apparatus 20a, the cloud service system 1 may provide a service of storing, in a predetermined storage, image data of a document scanned by the image forming apparatus 20a and transmitted to the cloud service system 1 from the image forming apparatus 20a, or delivering the image data to a predetermined delivery destination (such a service being referred to as “cloud scan service” hereinafter). Also, the cloud service system 1 may provide a service of having the image forming apparatus 20a download print data that has been uploaded in the cloud service system 1 beforehand and execute a print job based on the print data (such a service being referred to as “cloud print service” hereinafter).

Note that a service provided by the cloud service system 1 does not necessarily have to be a cloud service. For example, the cloud service system 1 may also act as a server side system of a general server-client system. Also, in some embodiments, the network N1 may be a local area network (LAN).

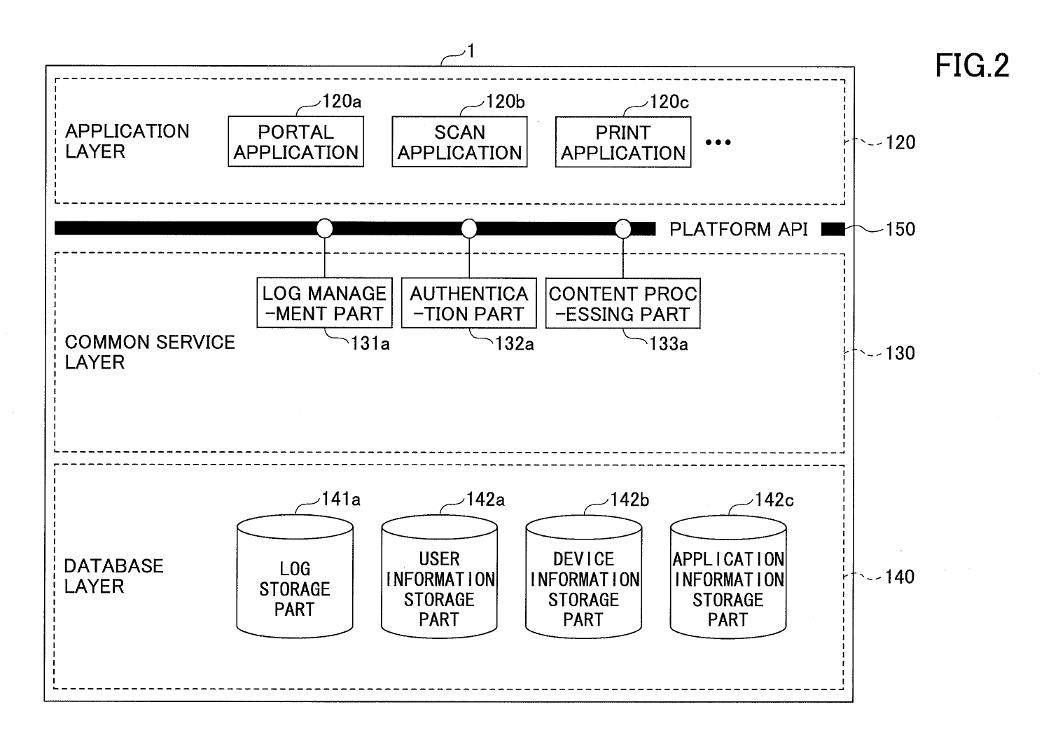

FIG. 2 illustrates an exemplary functional configuration of the cloud service system according to the first embodiment. In FIG. 2, functions of the cloud service system 1 are divided into an application layer 120, a common service layer 130, and a database layer 140.

The application layer 120 includes applications for implementing the services provided by the cloud service system 1 (referred to as “server applications” hereinafter). In FIG. 2, the application layer 120 includes a portal application 120a, a scan application 120b, and a print application 120c as exemplary server applications. The portal application 120a provides a portal site of a service provided by the cloud service system 1. The portal site may be used to register user information or set up setting information of each user with respect to a server application, for example. The scan application 120b executes processes related to the above cloud scan service. The print application 120c executes processes related to the above cloud print service.

The common service layer 130 includes functions common to multiple server applications or basic functions used by multiple server applications. In FIG. 2, the common service layer 130 includes a log management part 131a, an authentication part 132a, and a content processing part 133a. The log management part 131a may transfer a log related to a process executed at the allocation layer 120 or the common service layer 130 (simply referred to as “log” hereinafter) to a log storage part 141a, for example. The authentication part 132a executes processes on various types of data (content) such as data format conversion and an OCR (optical character recognition) process.

Functions of the common service layer 130 may be disclosed to the application layer 120 via a platform API (application programming interface) 150. That is, the application layer 120 is able to use the functions of the common service layer 130 that are disclosed via the platform API 150.

The database layer 140 includes a database (storage part) that stores relevant information of a process to be executed at the application layer 120 or the common service layer 130, for example. In FIG. 2, the database layer 140 includes a log storage part 141a, a user information storage part 142a, a device information storage part 142b, and an application information storage part 142c.

The log storage part 141a stores logs. The user information storage part 142a stores user attribute information of services provided by the cloud service system 1. The device information storage part 142b stores attribute information related to the devices 20 that cooperate with the cloud service system 1 to provide services. The application information storage part 142c stores setting information and other relevant information set up with respect to the server applications. For example, the setting information may be stored with respect to each user.

Note that the form of classification of software and storage parts illustrated in FIG. 2 is merely one example. The software and storage parts of the cloud service system 1 do not have to be hierarchically classified as illustrated in FIG. 2 in order to implement the present embodiment. That is, the hierarchical relationship between software and storage parts in the cloud service system 1 is not limited to particular relationships as long as the hierarchical relationship allows the devices 20 such as the image forming apparatus 20a to cooperate with the application layer 120, for example.

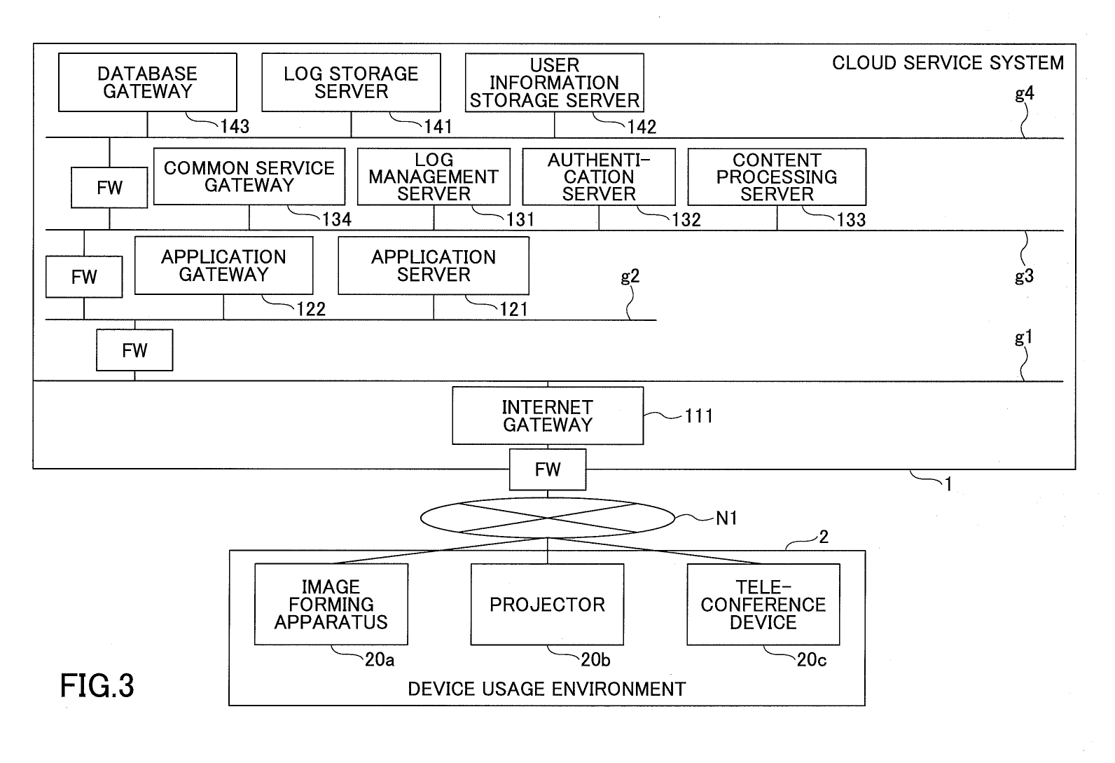

FIG. 3 illustrates an exemplary network configuration of the cloud service system according to the first embodiment. Note that in FIG. 3, features that are identical to those illustrated in FIG. 1 are given the same reference numerals and their descriptions are omitted.

In FIG. 3, a network included in the cloud service system 1 is divided into a plurality of segments (subnets) such as segments g1, g2, g3, and g4. In the following descriptions, the segments g1-g4 may simply be referred to as “segment g” when their distinctions are not particularly relevant.

The segment g1 is a segment positioned at the forefront with respect to the network N1. In FIG. 3, an Internet gateway 111 is connected to the segment g1. The Internet gateway 111 is a computer that allocates a request from the network N1 to a segment g according to its destination. In the present embodiment, a request from the network N1 corresponds to a request transmitted from one of the devices 20. In the following descriptions, such a request is simply referred to as “request.”

The segment g2 is a segment corresponding to the application layer 120. In FIG. 3, an application server 121 and an application gateway 122 are connected to the segment g2. The application server 121 is a computer having server applications such as the portal application 120a, the scan application 120b, and the print application 120c installed therein. The application gateway 122 is a computer that may perform load distribution of processes according to requests to the application server 121 or determine whether to allow or disallow passage of a request through the segment g2, for example. Note that although the application server 121 is represented by one rectangle in FIG. 3, a plurality of application servers 121 may be provided. In such a case, the application gateway 122 may distribute requests to the plurality of application servers 121.

The segment g3 is a segment corresponding to the common service layer 130. In FIG. 3, a log management server 131, an authentication server 132, a content processing server 133, and a common service gateway 134 are connected to the segment g3. The log management server 131 is a computer that implements the function of the log management part 131a. The authentication server 132 is a computer that implements the function of the authentication part 132a. The content processing server 133 is a computer that implements the function of the content processing part 133a. The common service gateway 134 is a computer that may perform load distribution of processes related to common services or determine whether to allow or disallow passage of a process request through the segment g3, for example. Note that although the log management server 131, the authentication server 132, and the content processing server 133 are each represented by one rectangle in FIG. 3, a plurality the above servers may be provided. In such a case, the common service gateway 134 may distribute process requests to the plurality of servers.

Note that process requests to the log management server 131, the authentication server 132, and the content processing server 133 may be arranged in a format conforming to the platform API 150. The platform API 150 may be a REST (representational state transfer) based API or some other type of API implemented via a network, for example.

The segment g4 is a segment corresponding to the data base layer 140. In FIG. 3, a log storage server 141, a user information storage server 142, and a database gateway 143 are connected to the segment g4. The log storage server 141 is a computer that implements the function of the log storage part 141a. The user information storage server 142 is a computer that implements the functions of the user information storage part 142a, the device information storage part 142b, and the application information storage part 142c. The database gateway 143 may perform load distribution of processes according to process requests allocated to the segment G4 or determine whether to allow or disallow passage of a process request to the segment g4. Note that although the log storage server 141 and the user information storage server 142 are each represented by one rectangle, a plurality of log storage servers 141 and a plurality of user information storage servers 142 may be provided, for example. In such a case, the database gateway 143 may distribute process request to the plurality of log storage servers 141.

Note that firewalls FW are arranged between the segments g and between the network N1 and the segment g1.

In the network configuration as illustrated in FIG. 3, higher security may be ensured for computers managing important information. For example, unique information of the device usage environment 2 (unique information of a user) may be included in a log to be stored in the log storage server 141. Such a log must be prevented from being accessed and stolen by an outsider. Thus, in the present embodiment, the log storage server 141 is connected to the segment g4, which is the most remotely positioned segment with respect to the network N1. Also, the user information storage server 142 is connected to the segment g4 in FIG. 3 for similar reasons.

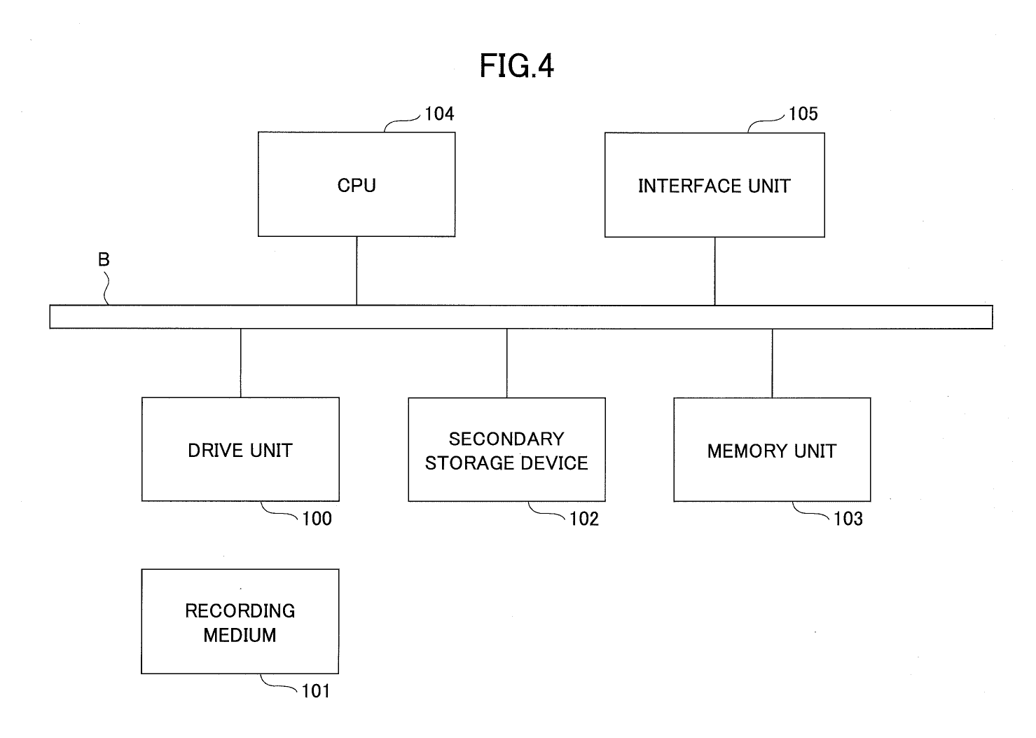

FIG. 4 illustrates an exemplary hardware configuration of each computer included in the cloud service system according to the first embodiment. Note that in the following descriptions, “computer” is used as a generic term for the components of FIG. 3 such as the internet gateway 111, the application gateway 122, the application server 121, the common service gateway 134, the log management server 131, the authentication server 132, the content processing server 133, the database gateway 143, the log storage server 141, and the user information storage server 142, for example.

As illustrated in FIG. 4, the computer includes a drive unit 100, a secondary storage device 102, a memory unit 103, a central processing unit (CPU) 104, and an interface unit 105 that are interconnected by a bus B.

A program for implementing a process at the computer may be provided by a recording medium 101 such as a CD-ROM. When the recording medium 101 storing the program is loaded in the drive unit 100, the program may be installed in the secondary storage device 102 from the recording medium 101 via the drive unit 100. However, the program does not necessarily have to be installed from the recording medium 101, and may alternatively be downloaded from another computer via a network, for example. The secondary storage device 102 stores files and data as well as installed programs.

The memory unit 103, in response to a command to activate a program, reads the program from the secondary storage device 102 and stores the read program. The CPU 104 executes functions of the computer in accordance with a program stored in the memory unit 103. The interface unit 105 is used as an interface for establishing connection with a network.

Note that the functional components of the application layer 120 and the common service layer 130 illustrated in FIG. 2 may be implemented by running the program installed in the computer and prompting the CPU 104 to execute a corresponding process based on the installed program. Also, the functional components of the database layer 140 may be implemented using the secondary storage device 102 of the computer, for example.

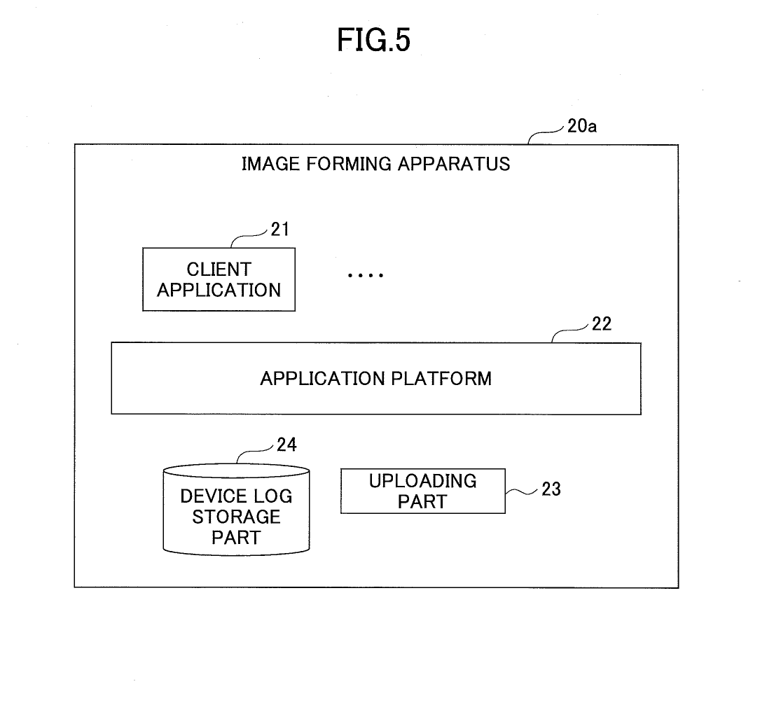

FIG. 5 illustrates an exemplary software configuration of the image forming apparatus 20a. In FIG. 5, the image forming apparatus 20a includes at least one client application 21, an application platform 22, an uploading part 23, and a device log storage part 24.

The client application 21 is an application that cooperates with one of the server applications to provide a service of the server application to a user. The server application and the client application 21 are basically arranged to correspond to each other on a one-to-one basis. Thus, for example, when a user wishes to use the cloud scan service, the user has to install a client application 21 corresponding to the cloud scan service in the image forming apparatus 20a.

The application platform 22 includes an API for developing the client application 21 and an execution environment for the client application 21. The API may be in the form of a set of functions, or object-oriented classes and class methods, for example. The application platform 22 may provide an API related to a scan function, an API related to a print function, and an API related to a copy function to the client application 21, for example. In one embodiment, the application platform 22 may include the Java (registered trademark) VM (virtual machine). In this case, the client application 21 may be implemented using the Java programming language.

The application platform 22 may also have a mechanism for enabling cooperation between the server application and the client application 21, and a function to record a log related to a process executed at the image forming apparatus (referred to as “device log” hereinafter), for example.

The device log storage part 24 stores a device log. The device log storage part 24 may be implemented using a secondary storage device included in the image forming apparatus 20a or a storage device connected to the image forming apparatus 20a via a network, for example.

The uploading unit 23 executes a process for uploading a device log stored in the device log storage part 24 to the log storage server 141.

Note that devices 20 other than the image forming apparatus 20a such as the projector 20b and the teleconference device 20c may have software configurations similar to that illustrated in FIG. 5.

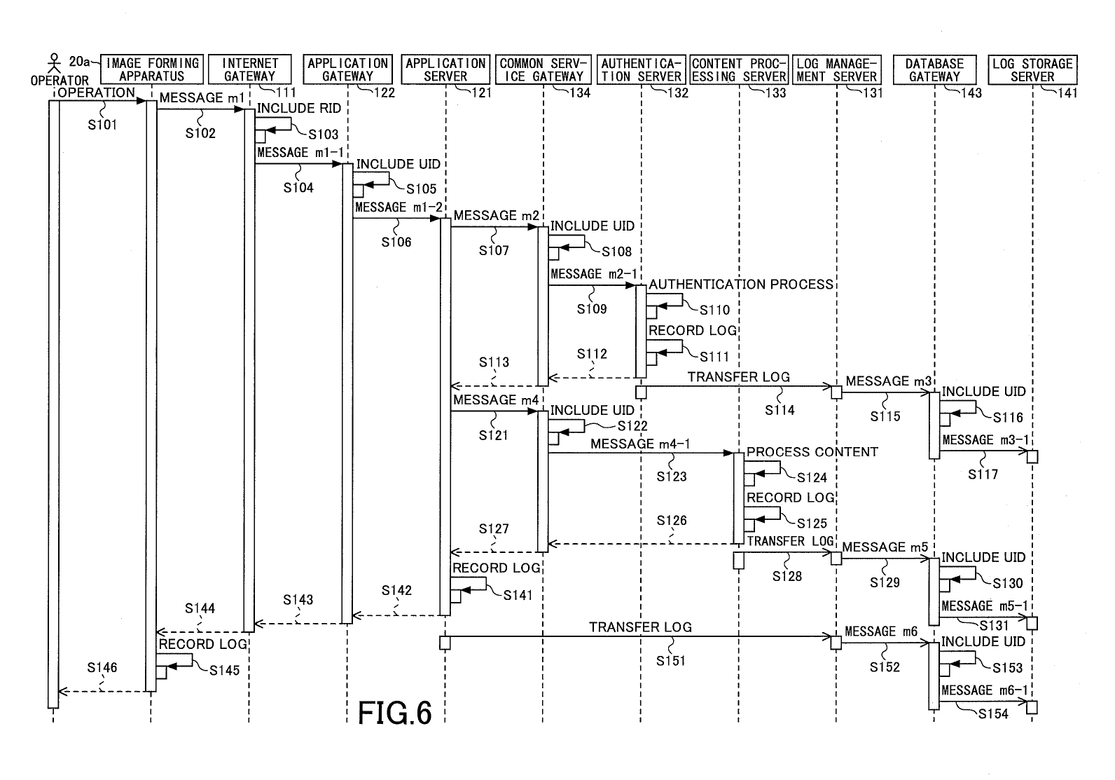

In the following, process steps executed in the cloud service system 1 are described. FIG. 6 is a sequence chart illustrating exemplary process steps of a log recording process implemented in the cloud service system 1. In the example illustrated in FIG. 6, it is assumed that the client application 21 corresponding to the cloud print service (print application 120c) of the image forming apparatus 20a is to be operated. Note, however, that the process steps of FIG. 6 are exemplary process steps for implementing a log recording process. That is, the cloud print service does not necessarily have to be executed according to the process steps as illustrated in FIG. 6.

In step S101, some type of operation is made by an operator of the image forming apparatus 20a. In the case where a request has to be sent to the cloud service system 1 in response to the operation, the client application 21 sends a message including the request to the print application 120c via the application platform 22 (step S102).

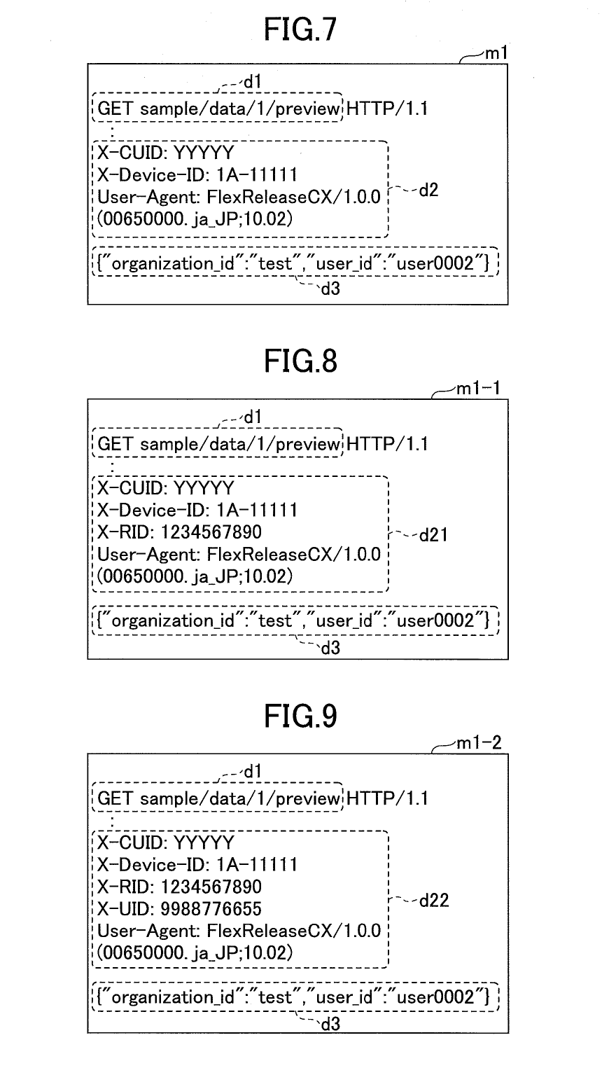

FIG. 7 illustrates an exemplary message including a request from the image forming apparatus 20a. In the present embodiment, it is assumed that messages are exchanged between the image forming apparatus 20a and the cloud service system 1 through HTTP (hypertext transfer protocol) communication. Thus, the message m1 illustrated in FIG. 7 conforms to the HTTP message format. However, when some other communication protocol is used, the message m1 may be in the format conforming to the communication protocol being used.

Description d1 in message m1 describes a process being requested. In FIG. 7, “GET sample/data/preview” is indicated as the process being requested. Note that “sample/data/preview” may refer to a list of print data registered in the cloud service system 1, for example.

Description d2 in message m1 includes fields (items) of the message header. Each field is represented in the format <field name>: <value>. For example, the value of field “X-CUID” corresponds to identification information called CUID (client unique ID). In the present embodiment, CUID corresponds to identification information assigned to each predetermined process unit of the image forming apparatus 20a. In the present embodiment, an example of a predetermined process unit of the image forming apparatus 20a may correspond to a sequence of processes that are executed from when an operation made by an operator is detected until a response corresponding to the operation is output. The CUID may be assigned to each and every operation including an operation for simply prompting a screen transition, for example. Alternatively, the CUID may be assigned to each operation that triggers transmission of a message to the cloud service system 1, for example. The CUID may be assigned by the application platform 22 of FIG. 5 that detects the operation made in step S101 of FIG. 6, for example. The application platform 22 may send a notification of the detected operation to the relevant client application 21 to be operated, for example.

The value of the field “X-Device-ID” may be a device number, for example. The device number refers to identification information assigned to each individual image forming apparatus 20a. For example, a manufacturer serial number or a MAC (media access control) address may be used as the device number. The device number may be stored in a storage device of the image forming apparatus 20a, for example.

Note that field names that start with “X-” correspond to fields extended in the present embodiment.

The value of the field “User-Agent” may be a service name corresponding to the client application 21 to be operated. Note that the information included in parentheses in this field corresponds to version information of the application platform 22.

Description d3 of message m1 includes user information for identifying the operator. The user information may include an organization ID (“organization_id”) and a user ID (“user_id”), for example. The organization ID is identification information of the organization to which the user (operator) belongs. The user ID is identification information assigned to each user for identifying the user within the organization. In the present embodiment, the cloud service system 1 is configured to be used by a plurality of organizations (e.g., companies). Thus, even if a user ID may be unique within an organization, a common user ID may be used across different organizations, for example. Accordingly, the organization ID may be used as identification information in contemplation of such possible overlap of user IDs across different organizations, for example.

Note that the organization ID and the user ID may be input during a login operation performed before the process steps illustrated in FIG. 6 or in step S101 of FIG. 6, for example.

All messages addressed to the cloud service system 1 are first received at the Internet gateway 111. Thus, the message m1 is also received by the Internet gateway 111. Upon receiving the message m1, the Internet gateway 111 generates a request ID (RID) corresponding to identification information identifying a request from a device 20 and includes the generated RID in the message m1 (step S103). That is, the Internet gateway 111 generates a new RID having a new value each time a message (request) is received from outside the cloud service system 1 and includes the generated RID in the corresponding message. Thus, the CUID and the RID basically correspond to one another on a one-to-one basis.

Next, the Internet gateway 111 transfers a message m1-1 corresponding to the message m1 having the RID included therein to the application server 121 having the print application 120a installed therein (step S104).

FIG. 8 illustrates an exemplary message having the RID included therein. Note that in FIG. 8, features that are identical to those illustrated in FIG. 7 are given the same reference numerals and their descriptions are omitted. In the message m1-1 illustrated in FIG. 8, the description d2 of FIG. 7 is replaced by description d21. The description d21 of message m1-1 includes a field “X-RID” in addition to the fields included in description d2. The value of the field “X-RID” is the RID of the message. That is, the field “X-RID” is added in step S103.

The message m1-1 addressed to the application server 121 on the segment g2 is first received at the application gateway 122. The application gateway 122 generates a unique ID (UID) corresponding to identification information for identifying each message (process execution request) addressed to a server on the segment g2 and includes the generated UID in the message m1-1 (S105). That is, the application gateway 122 generates a new UID each time a message (request) is received from outside the segment g2 and includes the generated UID in the corresponding message.

Next, the application gateway 122 transfers a message m1-2 corresponding to the message m1-1 having the UID included therein to the application server 121, the destination of the message (step S106).

FIG. 9 illustrates an exemplary message having the UID included therein. Note that in FIG. 9, features that are identical to those illustrated in FIG. 8 are given the same reference numerals and their descriptions are omitted. In the message m1-2 illustrated in FIG. 9, the description d21 of FIG. 8 is replaced by description d22. The description d22 of message m1-2 includes a field “X-UID” in addition to the fields included in description d21. The value of the field “X-UID” is the UID of the message. That is, the field “X-UID” is added in step S105.

When the application server 121 receives the message m1-2, the print application 120c executes a process according to the request described in description d1 of the message m1-2. During execution of such a process, a process request may have to be issued to another server within the cloud service system 1. For example, an authentication request may have to be issued to the authentication server 132 (authentication part 132a). In this case, the print application 120c may transmit a message m2 including an authentication request to the authentication server 132 (step S107). In addition to including a description of the authentication request, the message m2 includes an “X-Device-ID” field, an “X-RID” field, a “User-Agent” field, and user information, for example. The field values of the fields included in the message m2 may be identical to the field values of the same field names included in the message m1-2. Also, the user information included in message m2 may be identical to the user information (description d3) included in the message m1-2. That is, a process request exchanged between servers within the cloud service system 1 based on a request from a device 20 is configured to include the RID assigned to the request and information items such as the device number, the service name, and user information included in the message describing the request. Accordingly, the RID, the device number, the service name, and the user information may be transmitted to each of the servers receiving such a process request. On the other hand, the message m2 does not include the UID included in the message m1-2. This is because the UID included in the message m1-2 is identification information for identifying the process request to the application server 121 whereas the message m2 is related to a process request to the authentication server 132.

The message m2 addressed to the authentication server 132 on the segment g3 is first received by the common service gateway 134. Upon receiving the message m2, the common service gateway 134 generates a UID for identifying each message addressed to a server on the segment g3 and includes the generated UID in the message m2 (step S108). That is, the common service gateway 134 generates a new UID each time a message (process request) is received from outside the segment g3 and adds a new field “X-UID” including the generated UID as the field value in the received message.

Next, the common service gateway 134 transmits a message m2-1 corresponding to the message m2 having the UID included therein to the authentication server 132 (step S109).

Upon receiving the message m2-1, the authentication server 132 executes an authentication process according to the authentication request included in the message m2-1 (step S110). Next, the authentication server 132 records a log related to the authentication process in the secondary storage device 102 within the authentication server 132 (step S111). In the following descriptions, a log recorded by a server within the cloud service system 1 is referred to as “server log.”

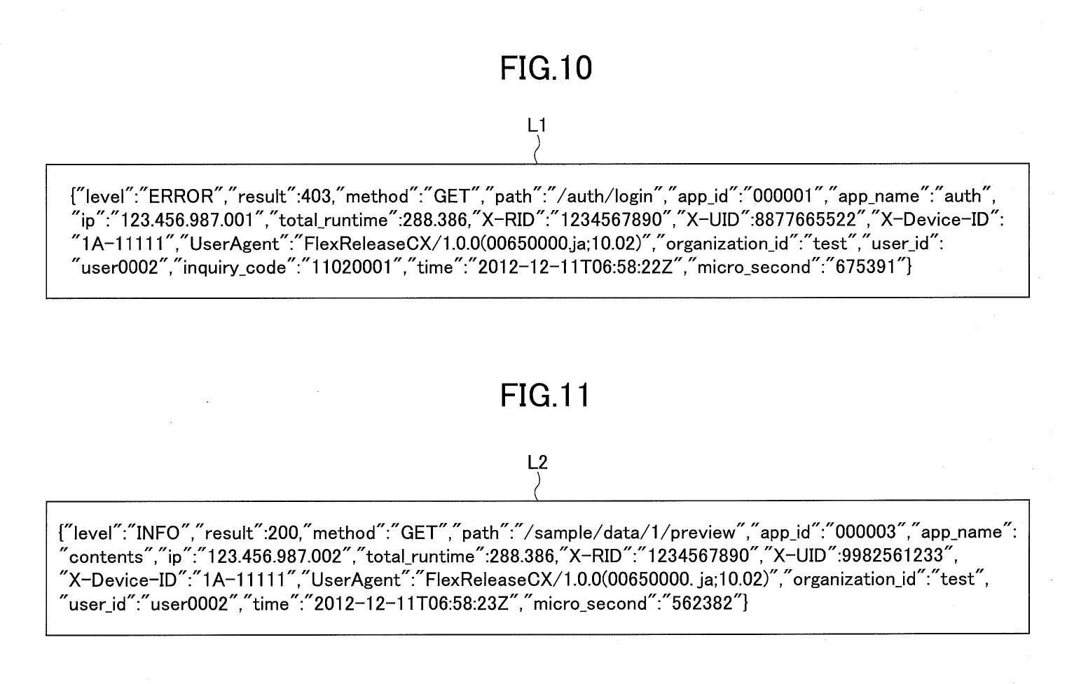

FIG. 10 illustrates an exemplary server log related to an authentication process. The server log L1 illustrated in FIG. 10 includes a plurality of fields (items). Each field is arranged into the format <filed name>:<value> and the fields are separated by a comma (,).

Specifically, the server log L1 of FIG. 10 includes a “level” field, a “result” field, a “method” field, a “path” field, an “app_id” field, an “app_name” field, an “ip” field, a “total_runtime” field, an “X-RID” field, an “X-UID” field, an “X-Device-ID” field, a “UserAgent” field, an “organization_id” field, a “user_id” field, an “inquiry_code” field, a “time” field, and a “micro_second” field.

The value of the “level” field indicates a level of the server log. The level of the server log refers to the content type of the server log. For example, potential field values of the “level” field include “INFO” and “ERROR”. “INFO” indicates that the corresponding server log includes information related a process that has been executed. “ERROR” indicates that the corresponding server log is related to an error.

The value of the “result” field is a numeric value (code) representing a result of the process executed by the authentication server 132. The value of the “method” field indicates a method included in the process request (message m2-1) to the authentication server 132. The value of the “path” field indicates a path of a URL (uniform resource locator) indicating the process request. The value of the “app_id” field corresponds to identification information assigned to a program module that has executed the process corresponding to the process request by the authentication server 132. That is, the value of the “app_id” field corresponds to an ID of the program module that prompts the authentication server 132 to implement the function of the authentication part 132a. The value of the “app_name” field indicates a name of the program module identified by the “app_id” field value assigned by a developer of the program module, for example. The value of the “ip” field indicates the IP address of the authentication server 132 that has executed the process corresponding to the process request. The value of the “total_runtime” field indicates the processing time of the process requested by the process request.

The value of the “X-RID” field indicates the RID of the request to which the process request belongs. The request to which the process request belongs refers to the request from the image forming apparatus 20a corresponding to the source of the process request. Thus, the value of the “X-RID” field included in the message m2-1 is transferred to the “X-RID” field of the server log L1. The value of the “X-UID” field indicates the UID assigned to the process request. Thus, the value of the “X-UID” field included in the message m2-1 is transferred to the “X-UID” field of the server log L1. The value of the “X-Device-ID” field corresponds to the device number of the image forming apparatus 20a corresponding to the sender of the request associated with the process request. Thus, the value of the “X-Device-ID” field included in the message m2-1 is transferred to the “X-Device-ID” field of the server log L1. The value of the “UserAgent” field indicates the service name of the service used by the image forming apparatus 20a corresponding to the sender of the request to which the process request belongs. Thus, the value of the “User-Agent” field included in the message m2-1 is transferred to the “UserAgent” field of the server log L1.

The value of the “organization_id” field represents the organization ID of the corresponding organization of the image forming apparatus 20a that has sent the request associated with the process request. Thus, the organization ID included in the message m2-1 is transferred to the “organization_id” field of the server log L1.

The value of the “user_id” field represents the user ID of the operator of the image forming apparatus 20a corresponding to the sender of the request associated with the process request. Thus, the user ID included in the message m2-1 is transferred to the “user_id” field of the server log L1.

The “inquiry_code” field may be a valid field in the case where “ERROR” is the field value of the “level” field. In such a case, the value of the “inquiry_code” field is a numeric value specifying the error (error code). The value of the “time” field indicates the time and date when the server log L1 was recorded. The value of the “micro_second” field represents the time the server log L1 was recorded in microsecond units.

Next, the authentication server 132 transmits a response to the message m2-1 (step S112). The response may include information indicating whether or not the authentication process was successful, for example. The response is transmitted to the application server 121 via the common service gateway 134 (step S113). More specifically, the response is transmitted to the application server 121 via the common service gateway 134 and the application gateway 122.

Also, the authentication server 132 transmits the server log L1 recorded in step S111 to the log management server 131 (log management part 131a) at a suitable timing (step S114). Note that recording of the server log L1 and transmission of the server log may be may be executed asynchronously. Upon receiving the server log L1, the log management server 131 transmits a message m3 including a storage request for storing the server log L1 to the log storage server 141 (step S115).

In addition to including a description of the server log L1 itself and a description of the storage request for storing the server log L1, the message m3 includes an “X-Device-ID” field, an “X-RID” field, a “User-Agent” field, and user information, for example. The field values of the fields included in the message m3 may be identical to the field values of the same field names included in the message m2-1. Also, the user information included in the message m3 may be identical to the user information included in the message m2-1.

The message m3 addressed to the log storage server 141 on the segment g4 is first received by the database gateway 143. Upon receiving the message m3, the database gateway 143 generates a UID for identifying each message addressed to a server on the segment g4 and includes the generated UID in the message m3 (step S116). That is, the database gateway 143 generates a new UID each time a message (process request) is received from outside the segment g4 and adds a new field “X-UID” including the generated UID as the field value in the received message.

Next, the database gateway 143 transmits a message m3-1 corresponding the message m3 having the generated UID included therein to the log storage server 141 (step S117). Upon receiving the message m3-1, the log storage server 141 may store the server log L1 related to the authentication process included in the message m3-1 in the secondary storage device 102 of the log storage server 141, for example. Next, it is assumed below that during execution of a process of the print application 120c of the application server 121 that has received the response from the authentication server 132, a process request related to content processing has to be made to the content processing server 133 (referred to as “content processing request” hereinafter). In this case, the print application 120c transmits a message m4 including the content processing request to the content processing server 133 (step S121). In addition to including a description of the content processing request, the message m4 includes an “X-Device-ID” field, an “X-RID” field, a “User-Agent” field, and user information, for example. The field values of the fields included in the message m4 may be identical to the field values of the same field names included in the message m1-2. Also, the user information included in the message m4 may be identical to the user information (description d3) included in the message m1-2. However, the message m4 does not include the UID included in the message m1-2.

The message m4 addressed to the content processing server 133 on the segment g3 is first received by the common service gateway 134. Upon receiving the message m4, the common service gateway 134 generates a UID for identifying each message addressed to a server on the segment g3 and includes the generated UID in the message m4 (step S122). Note that the UID included in the message m4 is different from the UID included in the message m1-2 addressed to the application server 121 in step S105 or the UID included in the message m2 addressed to the authentication server 132 in step S107. That is, the UID is identification information for identifying each process request exchanged between servers within the cloud service system 1.

As described above, in executing a plurality of processes based on a single request from the image forming apparatus 20a, a UID with a different value is preferably assigned to each process request or process to be executed in response to the request from the image forming apparatus 20a. That is, the UID is identification information for identifying or distinguishing each process or process request.

However, in the present embodiment, in step S105, the application gateway 122 generates and includes the UID in the message m1-2 whereas in steps S105 and S122, the common service gateway 134 generates and includes the UID in the message m2 or the message m4. That is, a plurality of units (gateways) are configured to generate and assign a UID with respect to a process request or a process to be executed in response to the same request from the image forming apparatus 20a. In such a case, even though the uniqueness of each UID generated by the same UID assigning unit (gateway) may be ensured, the uniqueness of each UID associated with the same RID cannot be ensured in the case where a plurality of gateways are configured to generate and assign a UID to a process request or process associated with the same request.

In this respect, for example, the UID may be randomly generated using random numbers. In another example, timers of the gateways may be synchronized and time information detected by the timers may be included in the UID. In yet another example, the gateways may be configured to establish communication with each other so that they may exchange UID values that have already been assigned. In another example, one gateway (e.g., the Internet gateway 111) may be configured to integrally manage UIDs that have already been assigned and the other gateways may be configured to make inquiries to the Internet gateway 111 regarding the UIDs that have already been assigned. The other gateways may be configured to assign a UID that has not yet been assigned and then notify the Internet gateway 111 of the newly assigned UID.

By implementing one of the above-described measures, for example, UIDs associated with the same RID may be prevented from overlapping. Note, however, that other measures may be implemented to avoid an overlap of the UIDs.

Next, the common service gateway 134 transmits a message m4-1 corresponding the message m4 having the generated UID included therein to the content processing server 133 (step S123).

Upon receiving the message m4-1, the content processing server 133 may execute content processing based on the content processing request included in the message m4-1 (step S124). Then, the content processing server 133 may store a server log related to the content processing in the secondary storage device 102 of the content processing server 133, for example (step S125).

FIG. 11 illustrates an exemplary server log related to content processing. The server log L2 related to content processing as illustrated in FIG. 11 includes the same fields as those included in the server log L1 related to an authentication process. That is, server logs generated by servers within the cloud service system 1 are arranged to have substantially the same fields. However, in some embodiments, a field unique to each server may be included in the server logs generated by the servers within the cloud service system 1. Also, the field values of the fields may be arranged to vary from server to server, for example. Also, as the field values of the “X-RID” field, the “X-UID” field, the “X-Device-ID” field, the “UserAgent” field, the “organization_id” field, and the “user_id” field of the server log L2, the field values of the corresponding field names included in the message m4-1 are transferred. That is, the field values of the “X-RID” field, the “X-Device-ID” field, the “UserAgent” field, the “organization_id” field, and the “user_id” field of server logs related to processes to be executed by servers based on the same request from the image forming apparatus 20a are arranged to be the same. In this way, a determination may be made as to whether certain server logs relate to processes executed in response to the same request from a device 20 by determining whether their field values for the “X-RID” field are the same, for example. On the other hand, the values of the “X-UID” fields of the server logs are arranged to differ according to each process request exchanged between the servers. For example, the field values of the “X-UID” fields of the server log L1 and the server log L2 are different. In this way, a determination may be made as to whether certain server logs relate to the same process request exchanged between the servers by determining whether their corresponding field values for the “X-UID” field are the same, for example.

Next, the content processing server 133 transmits a response to the message m4-1 (step S126). The response may include information relating to whether the requested content processing has been successfully executed, for example. The response is transmitted to the application server 121 via the common service gateway 134 (step S127). More specifically, the response is transmitted to the application server 121 via the common service gateway 134 and the application gateway 122.

Also, the content processing server 133 transmits the server log L2 recorded in step S125 to the log management server 131 (log management part 131a) at a suitable timing (step S128). Note that the transmission of the server log L2 may be performed asynchronously with respect to the recording of the server log L2. Upon receiving the server log L2, the log management server 131 includes the received server log L2 in a message m5 representing a storage request for storing the server log L2 to the log storage server 141 (step S129).

In addition to including a description of the server log L2 itself and a description of the storage request for storing the server log L2, the message M5 includes an “X-Device-ID” field, an “X-RID” field, a “User-Agent” field, and user information, for example. The field values of the fields included in the message m5 may be identical to the field values of the same field names included in the message m4-1. Also, the user information included in the message m5 may be identical to the user information included in the message m4-1.

Next, process steps similar to those performed with respect to the message m3 (steps S116 and S117) are performed with respect to the message m5 (steps S130 and S131). In this way, the server log L2 may be stored in the secondary storage device 102 of the log storage server 141.

Also, when the application server 121 receives the response from the content processing server 131 and when all relevant processes associated with the request from the image forming apparatus 20a are completed, the print application 120c records a server log related to a process executed by the print application 120c (step S141). The server log may be recorded in the secondary storage device 102 of the application server 121, for example.

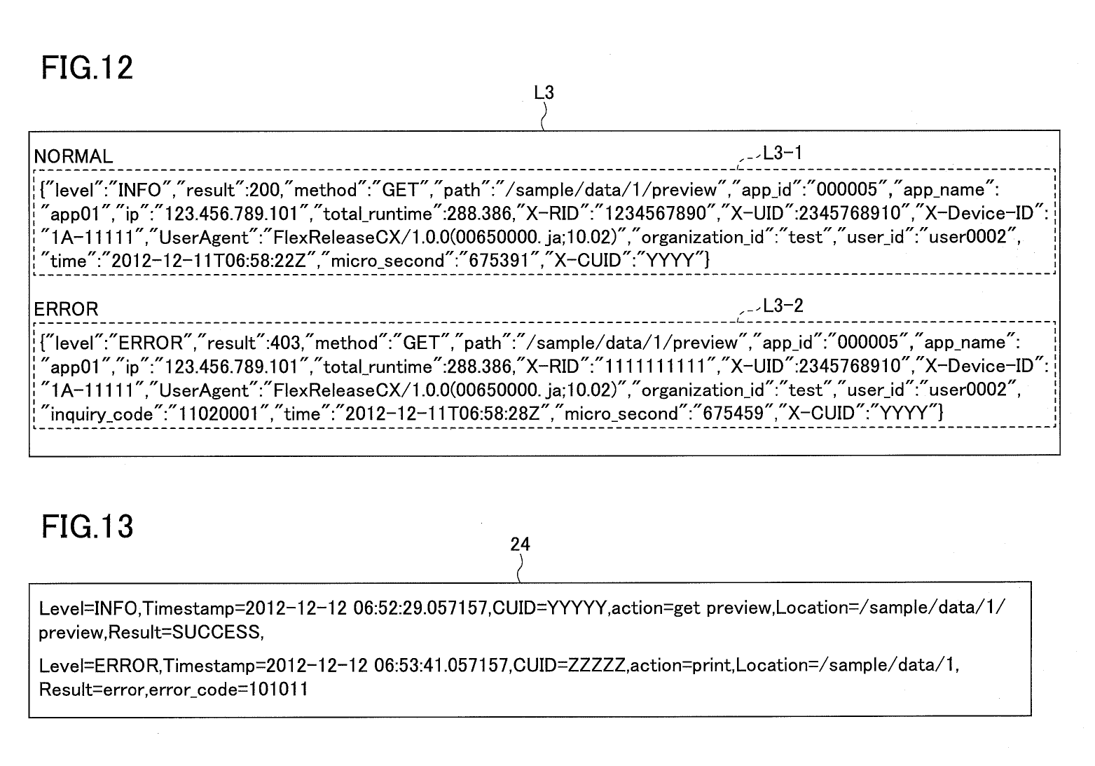

FIG. 12 illustrates exemplary server logs related to a process executed by the print application 120c. Specifically, FIG. 12 illustrates a server log L3-1 and a server log L3-2 as two exemplary server logs. The server log L3-1 represents an exemplary server log that may be recorded in a normal case where a process in response to a request from the image forming apparatus 20a is properly completed. The server log L3-2 represents an exemplary server log that may be recorded in an abnormal case where an error occurs in the execution of a process in response to a request from the image forming apparatus 20a. Accordingly, “ERROR” is indicated as the field value of the “level” field of the sever log L3-2. Note that in the following descriptions, the server logs L3-1 and L3-2 may be collectively referred to as “server log L3” when distinctions between the two are not particularly relevant.

The server log L3 includes a “X-CUID” field in addition to the fields included in the server logs L1 and L2 described above. In the example illustrated in FIG. 12, the “X-CUID” field is the last field of the server log L3. The value of the field “X-CUID” corresponds to the CUID included in the message m1-2 (see FIG. 9) with the request from the image forming apparatus 20a.

As described above, a server log recorded in the application server 121 that performs overall process control of the processes called by a request from a device 20 such as the image forming apparatus 20a includes the CUID in addition to the RID corresponding to the request. In this way, a correspondence between the RID and the CUID may be stored in the server log of the application server 121.

Note that as the field values of the “X-RID” field, the “X-UID” field, the “X-Device-ID” field, the “UserAgent” field, the “organization_id” field, and the “user_id” field of the server log L3, the field values of the corresponding field names included in the message m1-2 may be transferred.

Next, the print application 120c (application server 121) transmits a response to the message m1-2 (step S142). The response may include information indicating whether the process executed in response to the request included in the message m1-2 has been successfully executed, for example. The response may be transmitted to the image forming apparatus 20a via the application gateway 122 and the Internet gateway 111 (steps S143 and S144).

When the response is received at the image forming apparatus 20a, the application platform 22 stores a device log related to the process executed in response to the operation made in step S101 in the device log storage part 24 (step S145).

FIG. 13 illustrates an exemplary configuration of the device log storage part 24. In the example illustrated in FIG. 13, the device log storage part 24 stores device logs in chronological order. Each device log stored in the device log storage part 24 may include a “Level” field, a “Timestamp” field, a “CUID” field, an “action” field, a “Location” field, and a “Result” field, for example. Each field is arranged into the format <field name>:<field value> and the fields are separated by a comma (,). The value of the “Level” field indicates a level (type) of the device log. For example, potential field values of the “Level” field include “INFO” and “ERROR”. “INFO” indicates that the corresponding device log is related to a process that has been executed. “ERROR” indicates that the corresponding device log is related to an error.

The value of the “Timestamp” field represents the generation date/time of the device log. The value of the “CUID” field represents the CUID assigned to the user operation that has triggered the recording of the device log. That is, the CUID assigned to the operation made by the operator in step S101 is recorded as the field value of the field “CUID” in the device log to be recorded in step S145. Note that the “CUID” field value of the first device log listed in FIG. 13 corresponds to the CUID included in the message m1 (see FIG. 7). That is, the first device log of FIG. 13 corresponds to the device log recorded in step S145 of FIG. 6.

The value of the “action” field represents the actual content of the request to the cloud service system 1. The value of the “Location” field represents identification information of data to be processed according to the request represented by the field value of the “action” field. The value of the “Result” field indicates whether the process executed in response to the operation made in step S101 has been successfully completed. Note that “error” is indicated as the field value of the “Result” field of the second device log listed in FIG. 13, and in such a case, an “error_code” field is added to the device log. The value of the “error_code” field is a numeric value (error code) representing the type of error.

Note that the format of the fields included in the device log may be identical to the format of the fields included in the server logs recorded by the servers of the cloud service system 1.

After step S145, the relevant client application 21 to be operated prompts an operation panel of the image forming apparatus 20a to display a message indicating the result of the process executed in response to the operation made in step S101 (step S146).

Meanwhile, the application server 121 transmits the server log L3 recorded in step S141 to the log management server 131 (log management part 131a) at a suitable timing (step S151). Note that the transmission of the server log L3 may be performed asynchronously with respect to the recording of the server log L3. Upon receiving the server log L3, the log management server 131 includes the received server log L3 in a message m6 representing a storage request for storing the server log L3 and transmits the message m6 to the log storage server 141 (step S152).

Next, process steps similar to those performed with respect to the message m3 (steps S116 and S117) are performed with respect to the message m5. In this way, the server log L3 may be stored in the secondary storage device 102 of the log storage server 141.

In the following, an uploading process for uploading a device log recorded in the image forming apparatus 20a to the log storage server 141 is described.

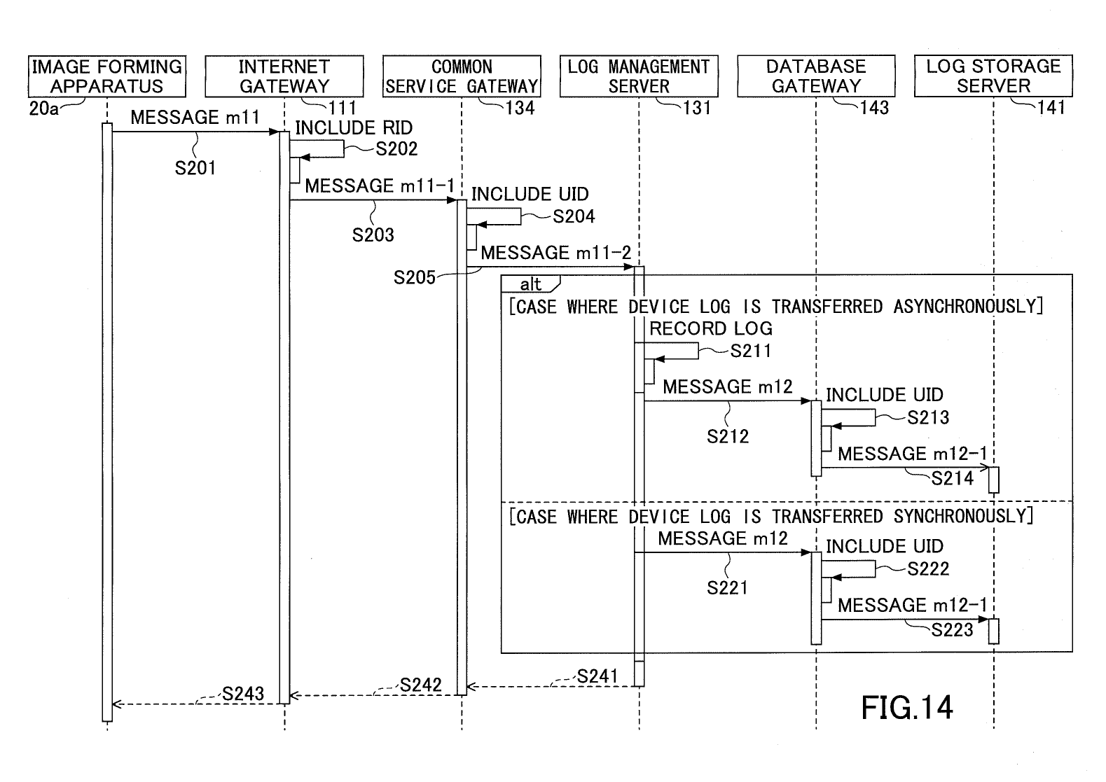

FIG. 14 is a sequence chart illustrating exemplary process steps of a device log uploading process.

In step S201, the uploading part 23 of the image forming apparatus 20a transmits a message m11 including a device log uploading request for uploading a device log stored in the device log storage part 24.

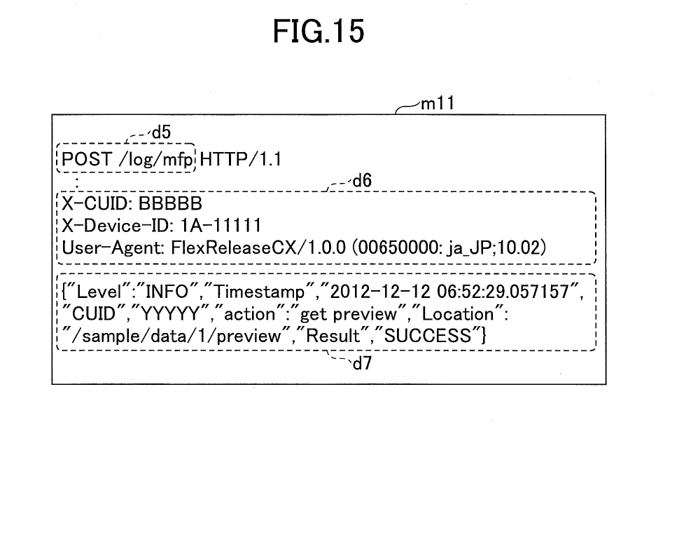

FIG. 15 illustrates an example of the message m11 including a device log uploading request. In the message m11 illustrated in FIG. 15, description d5 describes the content of the request (device log uploading request), and description d6 includes a “X-CUID” field, a “X-Device-ID” field, and a “User-Agent” field. The value of the “X-CUID” field represents a CUID that is newly assigned to the device log uploading request. That is, in the present embodiment, a CUID is assigned not only to a process to be executed in response to a user operation but also to a process that may be automatically started such as an operation for uploading a device log. The value of the “X-Device-ID” field represents the device number of the image forming apparatus 20a corresponding to the sender of the device log uploading request.

Description d7 of the message m11 illustrated in FIG. 15 includes the device log subject to the uploading operation. Note that although only one device log is included in the message m11 illustrated in FIG. 15, in other examples, the message m11 may include a plurality of device logs.

Step S201 of FIG. 14 may be executed synchronously or asynchronously with respect to the device log recording process of step S145 of FIG. 6. In the case where step S201 is executed asynchronously, step S201 may be executed on a periodic basis or at predetermined time points, or step S201 may be executed when a predetermined quantity of device logs are accumulated, for example.

As described above, all messages addressed to the cloud service system 1 are first received by the Internet gateway 111. Accordingly, the message m11 is received by the Internet gateway 111. Upon receiving the message mil, the Internet gateway 111 generates a RID with respect to the request included in the message m11 and includes the generated RID in the message m1l (step S202). For example, a new field “X-RID” including the generated RID as the field value may be added to the description d6 of the message m11 illustrated in FIG. 15.

Next, the Internet gateway 111 transfers a message m11-1 corresponding to the message m11 having the RID included therein to the log management server 131 (step S203).

The message m11-1 addressed to the log management server 131 on the segment g3 is first received at the common service gateway 134. The common service gateway 134 generates a UID with respect to the message m11-1 and includes the generated UID in the message m11-1 (S204). For example, a new field “X-UID” including the generated UID as the field value may be added to the description d6 of the message m11 illustrated in FIG. 15.

Next, the common service gateway 134 transmits a message m11-2 corresponding to the message m11-1 having the UID included therein to the log management server 131 (step S205).

FIG. 14 illustrates exemplary process steps that may be executed after the message m11-2 is received by the log management server 131 in two different cases. Specifically, case 1 corresponds to a case where the device log is transferred asynchronously with respect to the message m11-2. In case 1, process steps S211-S214 are executed. Case 2 corresponds to a case where the device log is transferred synchronously with respect to the message m11-2. In case 2, process steps S221-S223 are executed. Note that both case 1 and case 2 may be implemented in the present embodiment.

Where case 1 is implemented, the log server 131 records the device log included in the description d7 of the received message m11-2 in the secondary storage device 102 of the log management server 131 (S211). Then, the log management server 131 transmits a response to the message m11-2 (step S241).

Thereafter, the log management server 131 may include the device log recorded in step S211 in a message m12 representing a storage request for storing the device log and transmit the message m12 at a suitable timing to the log storage server 141 (step S212).

Note that in addition to including a description of the storage request for storing the device log, the message m12 may include a “X-Device-ID” field, an “X-RID” field, and a “User-Agent” field, for example. The field values of these fields may be the same as the field values of the corresponding field names included in the massage m11-2.

The message m12 addressed to the log storage server 141 on the segment g4 is first received by the database gateway 143. Upon receiving the message m12, the database gateway 143 generates a UID to the message m12 and includes the generated UID in the message m12 (step S213).

Next, the database gateway 143 transmits a message m12-1 corresponding the message m12 having the generated UID included therein to the log storage server 141 (step S214). Upon receiving the message m12-1, the log storage server 141 may store the device log included in the message m12-1 in the secondary storage device 102 of the log storage server 141, for example. In a preferred embodiment, the device log and the server log are separately stored.

Where case 2 is implemented, the log management server 131 extracts the device log from the description d7 of the received message m11-2, includes the device log in the message 12 representing the storage request for storing the device log, and transmits the message 12 to the log storage part 141 (step S221). Then, process steps similar to the above process steps S213 and S214 are performed (steps S222 and S223). In this way, the device log included in the message m12-1 may be recorded in the secondary storage device 102 of the log storage server 141. Then, the log management server 131 transmits a response to the message m11-2 (step S241).

Note that in both case 1 and case 2, the response transmitted in step S241 is transferred to the image forming apparatus 20a via the common service gateway 134 and the Internet gateway 111 (steps S242 and S243).

In some embodiments, a device log related to the device log uploading process may be recorded at the image forming apparatus 20a that receives the response from the log management server 131.

In the following, an exemplary manner of browsing logs such as server logs and device logs that have been stored in the log storage server 141 by the processes of FIGS. 6 and 14 is described. For example, log browsing may be performed by a developer or an administrator of the cloud service system 1 using a computer (not shown), which is referred to as “log browsing terminal” hereinafter.

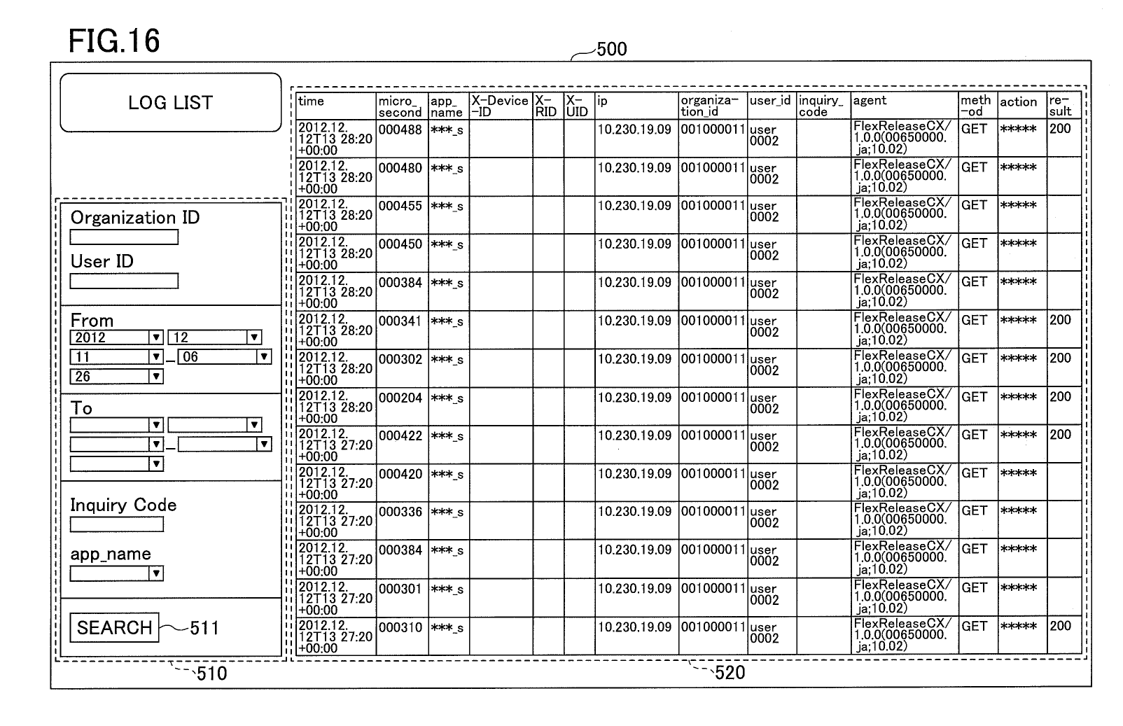

For example, the log browsing terminal may display a log browsing screen as illustrated in FIG. 16. FIG. 16 illustrates an exemplary display of a log browsing screen 500. The illustrated log browsing screen 500 includes a search condition input region 510 and a log display region 520.

The search condition input region 510 accepts an input of a value or value range for a field included in a server log as a search condition. In the example illustrated in FIG. 16, a field value for the “organization_id” field, a field value for the user-id” field, a field value range for the “time” field, a field value for the “inquiry_code” field, and a field value for the “app_name” field may be input as search conditions. Note that the search condition input region 510 may be configured to enable input of field values for other fields as well.

When a search condition is input into one of the input fields of the search condition input region 510 and a search button 511 is pressed, the log browsing terminal transmits a server log search request to the log management server 131. The search request designates the search condition input to the search condition input region 510. In response to the search request, the log management server 131 searches for sever logs matching the search condition from the sever logs stored in the log storage server 141. The log management server 131 then returns a list of server logs matching the search condition to the log browsing terminal.

The log browsing terminal them prompts the log display region 520 to display the list of server logs. The log display region 520 displays the field values of the fields of each server log that is listed. When one of the field values of one of the server logs displayed in the log display region 520 is selected by double-clicking the field value, for example, the log browsing terminal may transmit the selected field value as a search refinement condition to the log management server 131. In response to such a search request, the log management server 131 may further refine the search. For example, when a field value of the “X-RID” field is double-clicked, only server logs including the selected value as the RID may be displayed. Also, a device log including the CUID corresponding to the selected RID may be searched. In this way, a viewer of the log browsing screen may easily determine the correspondence between a process at the device 20 side and a process at the server side of a series of processes executed over a network.

Note that FIG. 16 merely illustrates one exemplary mode of log browsing. That is, the manner in which logs are browsed may be suitably adjusted and modified according to various purposes.

As described above, in the first embodiment, a CUID, which is assigned to a predetermined process unit at the device 20 side and recorded in a device log, and a RID, which is assigned to a request from the device 20 at the server side and recorded in each server log related to each process executed at the server side in response to the request are stored in association with each other. In this way, the correspondence between operations and processes at the device 20 side and processes at the server side may be accurately determined. Also, when an error occurs at the server side, the operation at the device 20 side that has triggered the error may be quickly determined, for example. Also, usage of a function at the server side by the device 20 side may be analyzed and useful information for marketing purposes may be derived, for example.

In the following, a second embodiment of the present invention is described. Note that features of the second embodiment that differ from the first embodiment are described below. Accordingly, it may be assumed that aspects of the second embodiment that are not particularly described below may be identical to the first embodiment.

In the second embodiment, the application platform 22 of the image forming apparatus 20a assigns a RID. That is, the application platform 22 assigns a RID to a message to be transmitted to the cloud service system 1, includes the RID in the message, and transmits the message including the RID to the cloud service system 1. In the present embodiment, a CUID does not necessarily have to be assigned. Thus, for example, in step S102 of FIG. 6, a message corresponding to the message m1-1 of FIG. 8 with the “X-CUID” field removed may be transmitted to the cloud service system 1.

In the present embodiment, the RID may include the device number of the image forming apparatus 20a and the identification information assigned to the message at the image forming apparatus 20a, for example. Such an arrangement may be favorable for purposes of avoiding an overlap of RIDs in the case where a plurality of image forming apparatuses 20a or other devices 20 are configured to assign an RID to a message to be transmitted to the cloud service system 1, for example.

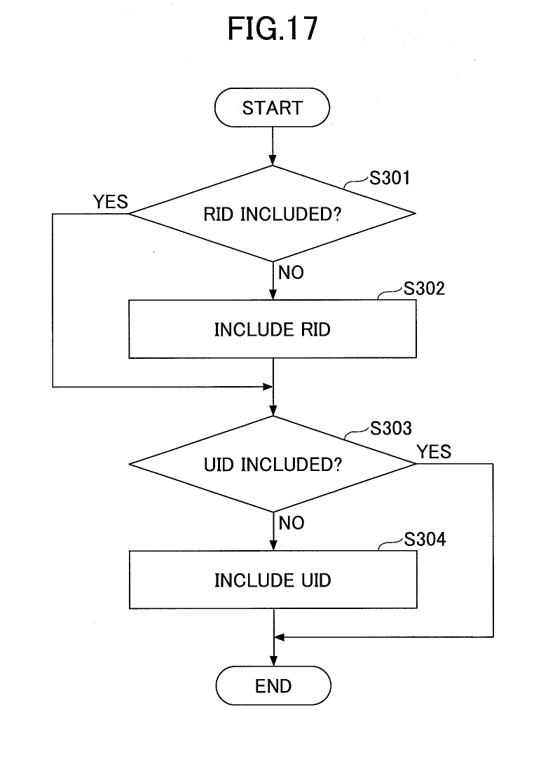

At the cloud service system 1 side, the Internet gateway 111, the application gateway 122, the common service gateway 134, and the database gateway 143 (generically referred to as “gateway” hereinafter) may execute process steps illustrated in FIG. 17 upon receiving the message from the image forming apparatus 20a.

FIG. 17 is a flowchart illustrating exemplary process steps that may be executed by each of the gateways upon receiving a message according to the second embodiment.

Upon receiving a message, the gateway determines whether a RID is included in the received message (step S301). If a RID is not included in the message (NO in step S301), the gateway generates a RID and includes the generated RID in the message (S302).

Next, the gateway determines whether a UID is included in the message (step S303). If a UID is not included in the message (NO in step S303), the gateway generates a UID and includes the generated UID in the message (step S304).

As can be appreciated from FIG. 17, the gateway does not generate a RID when it receives a message already including a RID. That is, in the second embodiment, a RID is usually assigned to a message at the image forming apparatus 20a, and the Internet gateway 111 does not normally assign a RID to the message from the image forming apparatus 20a. Thus, in the present embodiment, a RID that is generated at the image forming apparatus 20a is transferred to a message that is exchanged within the cloud service system 1, and the RID may be stored in a server log in association with a UID that is generated within the cloud service system 1.

Note that a message generated within the cloud service system 1 is an example of a message that may not have a RID assigned thereto by the image forming apparatus 20a.

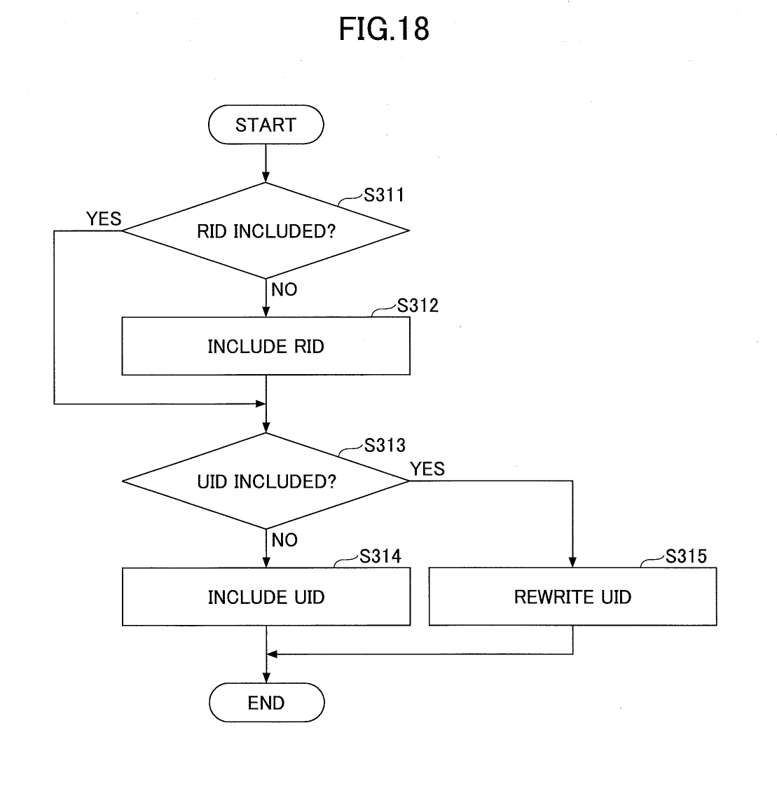

Also, in the second embodiment, each of the servers (computers other than the gateway) may perform process steps as illustrated in FIG. 18 upon receiving a message.

FIG. 18 is a flowchart illustrating exemplary process steps that may be executed by each of the servers upon receiving a message according to the second embodiment.

Upon receiving a message, the server determines whether a RID is included in the received message (step S311). If a RID is not included in the message (NO in step S311), the server generates a RID and includes the generated RID in the message (S312).

Next, the server determines whether a UID is included in the message (step S313). If a UID is not included in the message (NO in step S313), the server generates a UID and includes the generated UID in the message (step S314). If a UID is included in the message (YES in step S313), the server generates a new UID and replaces the UID included in the received message with the newly generated UID (step S315).

As can be appreciated from FIGS. 17 and 18, in the second embodiment, a UID is basically generated at each server rather than at the gateway. In this way a server that sends a request to another server may be easily tracked. In a preferred embodiment, identification information of the server may be included in the UID to further facilitate tracking of the servers.

In the following, a third embodiment of the present invention is described. Note that features of the third embodiment that differ from the second embodiment are described below. Accordingly, it may be assumed that aspects of the third embodiment that are not particularly described below may be identical to the second embodiment. Also, the third embodiment may be implemented in conjunction with the first embodiment.

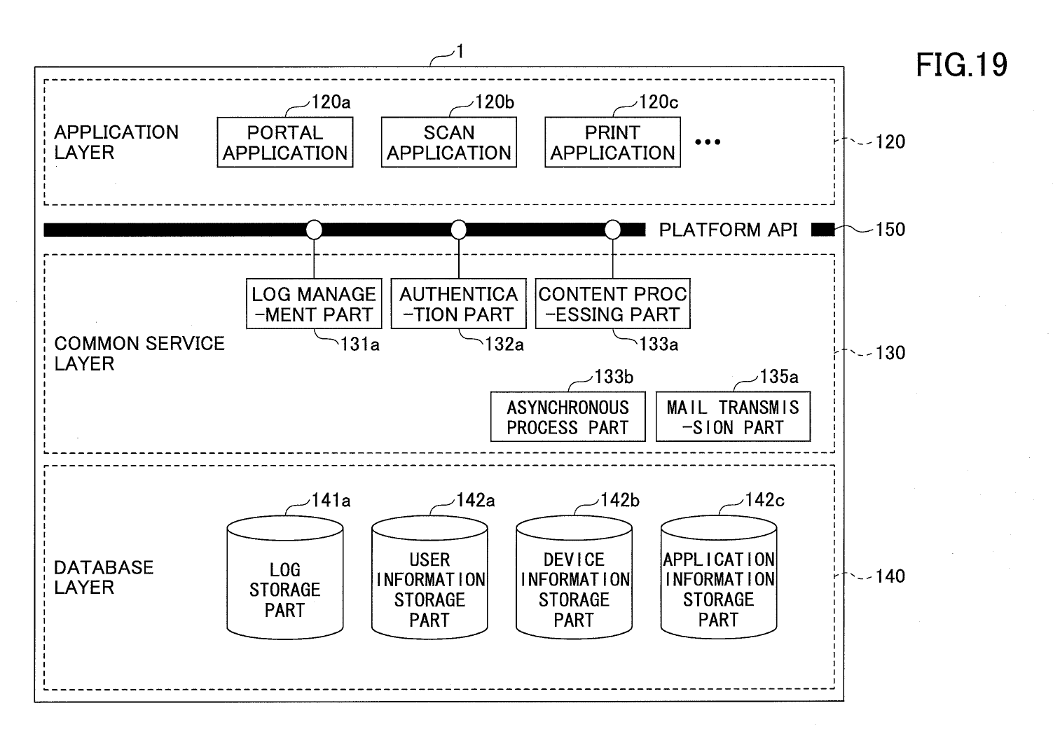

FIG. 19 illustrates an exemplary functional configuration of a cloud service system according to the third embodiment. In FIG. 19, the common service layer 130 further includes an asynchronous process part 133b and a mail transmission part 135a. The asynchronous process part 133b executes a process asynchronously with respect to a request. The mail transmission part 135a executes a mail transmission process. The third embodiment relates to an exemplary mechanism for determining a correspondence between a process and a request or RID even in a case where the process is executed asynchronously with respect to the request.

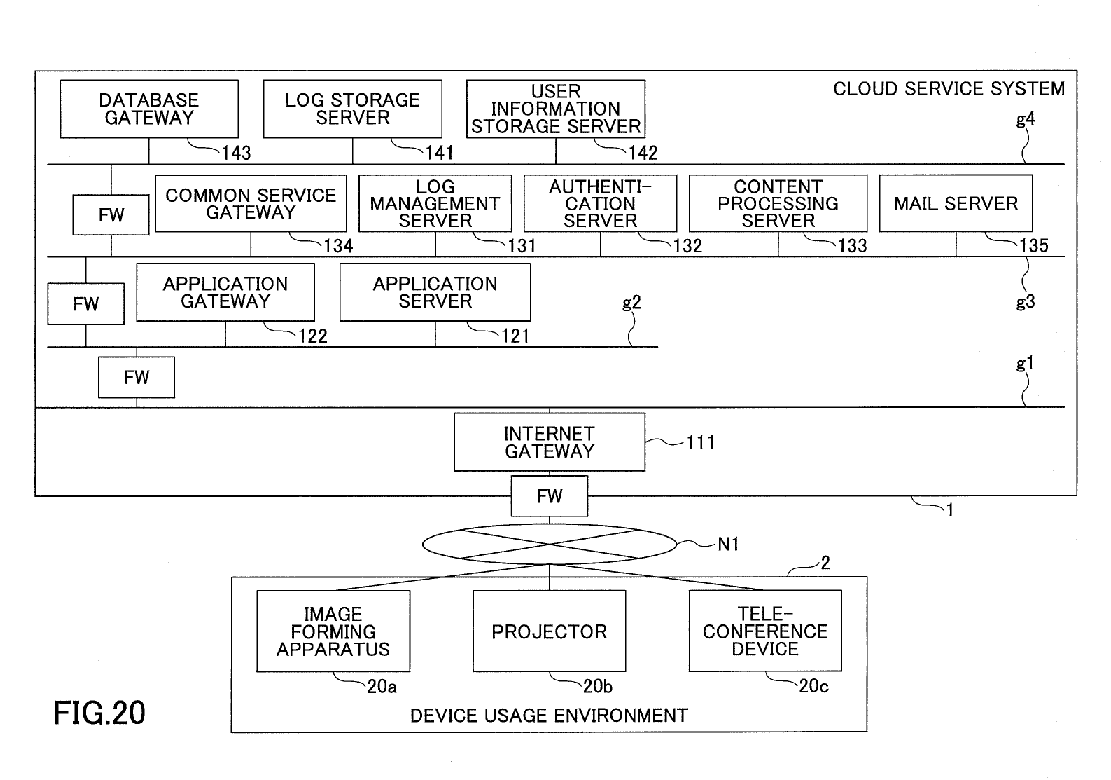

FIG. 20 illustrates an exemplary network configuration of the cloud service system 1 according to the third embodiment. In FIG. 20, a mail server 135 is additionally connected to the segment g3. The mail server 135 is a computer that is configured to implement the function of the mail transmission part 135a. Note that in the third embodiment, the content processing server 133 is also configured to implement the function of the asynchronous process part 133b.

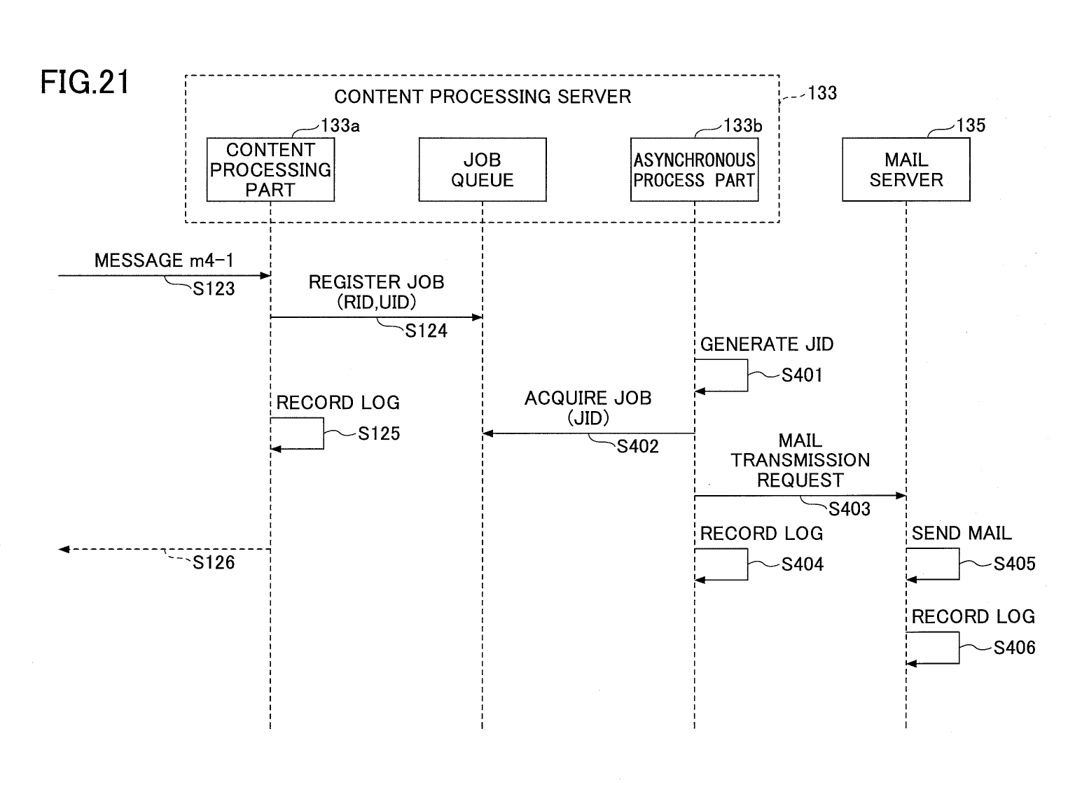

FIG. 21 is a sequence chart illustrating exemplary process steps that are executed in connection with an asynchronous process according to the third embodiment. Note that in FIG. 21, process steps that are identical to those illustrated in FIG. 6 are given the same reference numerals. In the third embodiment, for example, the process steps illustrated in FIG. 21 may be executed in response to the message m4-1 transmitted from the common service gateway 134 in step S123.

Upon receiving the message m4-1, the content processing part 133a of the content processing server 133 executes the process steps illustrated in FIG. 18. Then, the content processing part 133a registers information related to a job requested in the message m4-1 (referred to as “job information”) in a job queue (step S124). That is, in the third embodiment, the content process executed by the content processing part 133a corresponds to a registration process for registering a job in the job queue. The job information may include data to be processed, a RID, and a UID, for example. The RID included in the job information may correspond to the RID included in the message m4-1. The UID included in the job information may correspond to the UID generated or rewritten in the process of FIG. 18 executed by the content processing server 133 after receiving the message m4-1. Note that the job queue corresponds to a storage area such as a FIFO (first in first out) type storage area that may be implemented by the secondary storage device 102 or the memory unit 103 of the content processing server 133, for example.

Next, the content processing part 133a records a server log related to the content process in the secondary storage device 102 of the content processing server 133 (step S125).

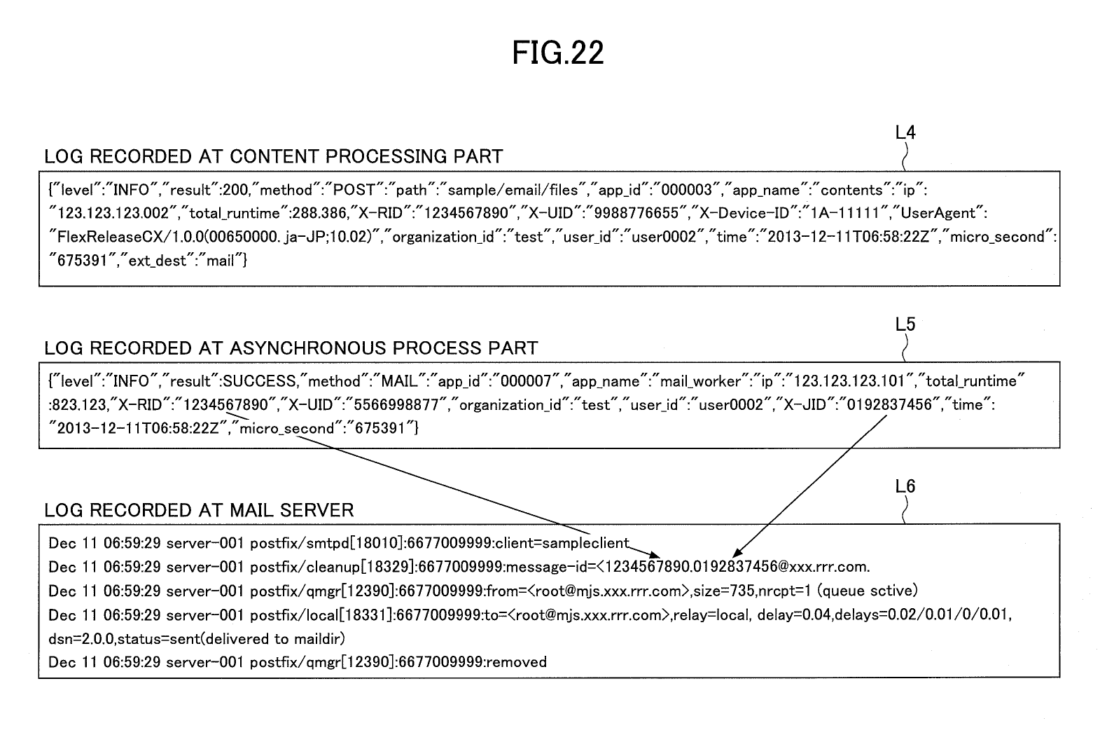

FIG. 22 illustrates exemplary server logs that may be recorded in the third embodiment. Specifically, in FIG. 22, server log L4 represents an exemplary server log that may be recorded in step S125. The server log L4 has a configuration similar to that of the server log L2 illustrated in FIG. 11. However, the field value of the “path” field of the server log L4 is different from that of the server log L2 of FIG. 11. That is, as illustrated in FIG. 22, the field value of the “path” field of the server log L4 is “/sample/email/files” representing a mail transmission request for a group of files. In step S124, job information describing the mail transmission request for the group of files is registered in the job queue based on the above field value.

Next, the content process part 133a transmits a response to the message m4-1 (step S126).

Meanwhile, the asynchronous process part 133b of the content processing server 133 periodically monitors the job queue. In monitoring the job queue, the asynchronous process part 133b generates a job ID (JID) corresponding to identification information for identifying each job to be executed by the asynchronous process part 133b (step S401). Next, the asynchronous process part 133b acquires job information from the job queue (step S402). In a preferred embodiment, the generated JID may be stored in association with the job information in the job queue. In this way, the job information registering side (the content process part 133a in the present example) may be informed of the JID corresponding to the job stored in the job queue. In a further embodiment, the JID may be used to check an execution status of a job, for example. Note that job information may not be acquired in step S402 when the job queue is empty. In such a case, the JID generated in a previous monitoring session may be used to in the next monitoring session, for example.

When job information is obtained in step S402, the asynchronous process part 133b sends a process request to a relevant server that is capable of executing the process called by the acquired job information. In the present example, the job information is related to a mail transmission request for a group of files. Thus, the asynchronous process part 133b sends a mail transmission request for the group of files to the mail server 135 (step S403).

Next, the asynchronous process part 133b records a server log related to the asynchronous process in the secondary storage device 102 of the content processing server 133 (step S404). Server log L5 of FIG. 22 represents an exemplary server log related to an asynchronous process that may be recorded in step S404. The configuration of the server log L5 is basically similar to the other server logs described above. Note, however, that the server log L5 includes a “X-JID” field. The field value of the “X-JID” field corresponds to the JID generated in step S401. By recording the server log L5, the correspondence between the RID, the UID, and the JID may be recorded.

Meanwhile, the mail server 135 that receives the mail transmission request for the group of files transmits the requested group of files via email in response to the mail transmission request (step S405). Next, the mail server 135 records a server log related to the mail transmission process in the secondary storage device 102 of the mail server 135 (step S406). Server log L6 of FIG. 22 represents an exemplary server log related to a mail transmission process that may be recorded in step S406. Note that although the server log L6 illustrated in FIG. 22 has a configuration differing from those of the other server logs, the server log L6 may alternatively be arranged to have a configuration similar to the other server logs.

The server log L6 includes information on the correspondence between the RID and the JID. Specifically, in FIG. 22, the server log L6 includes a “message_id” field including the RID and the JID that are connected together as its field value. In this way, the correspondence between the RID and the JID may be stored in the server log L6.

Note that a job to be executed based on job information does not necessarily have to be executed at once. For example, a job to be executed based on one set of job information may be divided into plural job units and executed separately by the asynchronous process part 133b. In such a case, a different JID may be assigned to each of the job units and a server log related to each job unit may be recorded, for example.

As described above, in the third embodiment, a JID is assigned to a process (job) that is executed asynchronously with respect to a request including a RID, and the correspondence between the RID and the JID is recorded in a server log. In this way, even when processes associated with a request from a device 20 are performed asynchronously, the correspondence between operations and processes at the device 20 side and processes at the server side may still be determined.

In the following, a fourth embodiment of the present invention is described. Note that features of the fourth embodiment that differ from those of the second and third embodiments are described below. Accordingly, it may be assumed that aspects of the fourth embodiment that are not particularly described below may be identical to the second and third embodiments. The fourth embodiment may also be implemented in conjunction with the first embodiment.

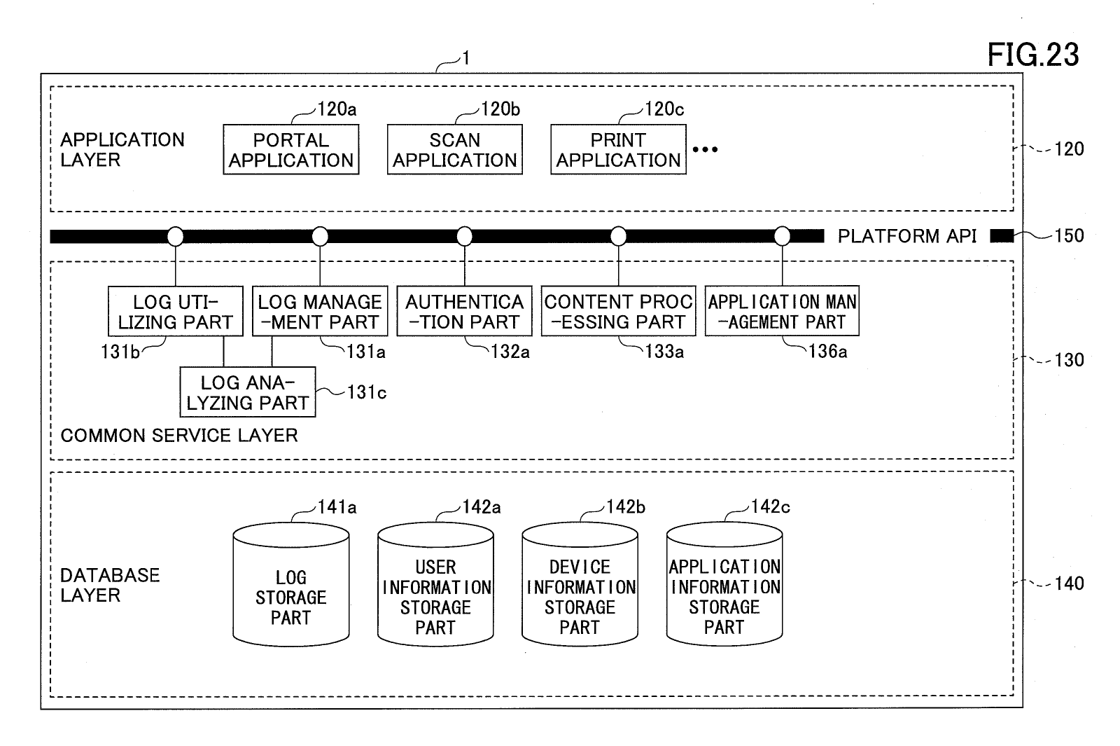

FIG. 23 illustrates an exemplary functional configuration of the cloud service system 1 according to the fourth embodiment. In FIG. 23, the common service layer 130 additionally includes a log utilizing part 131b, a log analyzing part 131c, and an application management part 136a.

The log utilizing part 131b provides an API for enabling utilization of a log stored in the log storage part 141a (log storage server 141) as a part of the platform API 150. The log analyzing part 131c analyzes or counts relevant logs stored in the log storage part 141a. The application management part 136a executes a process related to a server application provided in the application layer 120.

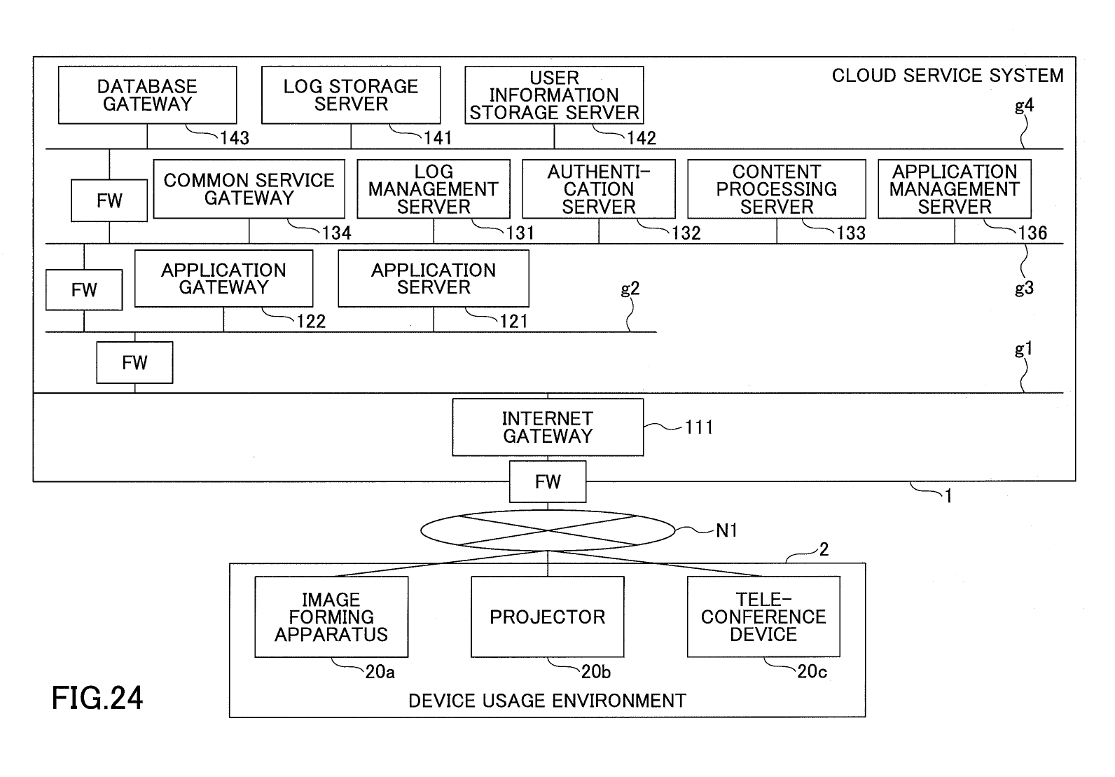

FIG. 24 illustrates an exemplary network configuration of the cloud service system 1 according to the fourth embodiment. In FIG. 24, an application management server 136 is connected to the segment g3. The application management server 136 is a computer that is configured to implement the function of the application management part 136a. Note that in the fourth embodiment, the log management server 131 is also configured to implement the function of the log utilizing part 131b and the log analyzing part 131c.

The fourth embodiment is described below in connection with an exemplary API that may be provided by the log utilizing part 131b (referred to as “log utilizing API” hereinafter).

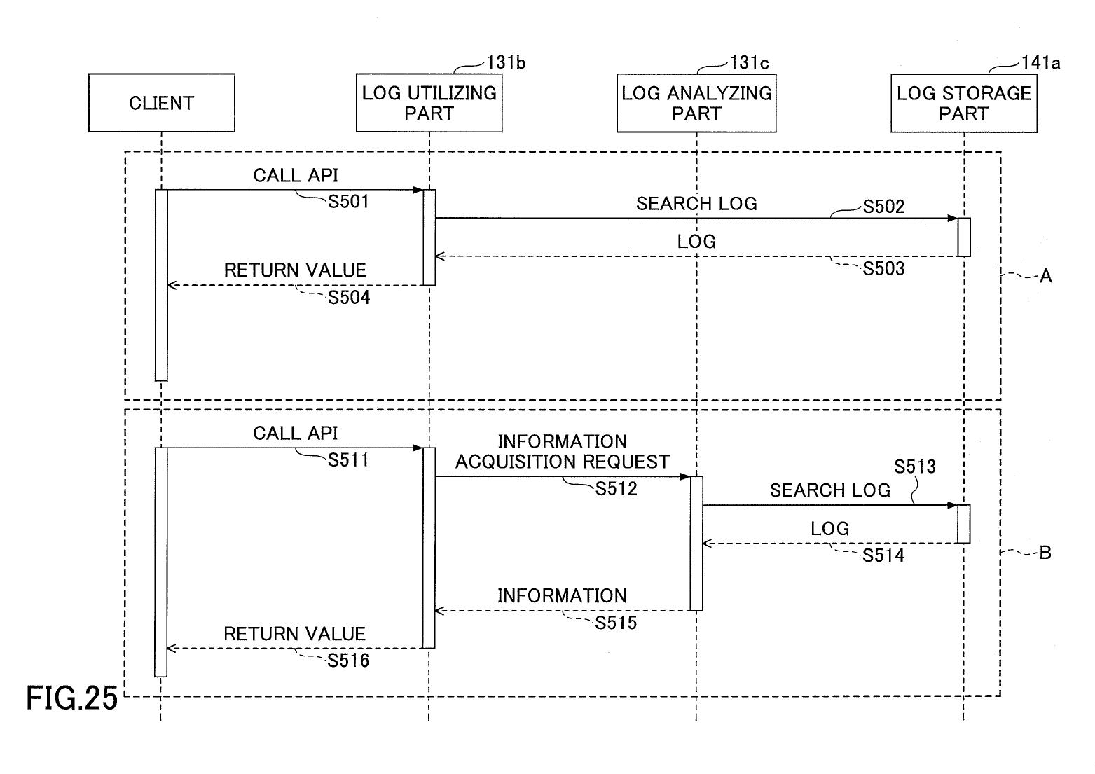

FIG. 25 is a sequence chart illustrating exemplary process steps that may be executed in response to a call for a log utilizing API. FIG. 25 illustrates two different cases; namely, case A where steps S501-S504 are executed, and case B where steps S511-S516 are executed. Note that steps S511-S516 do not necessarily have to be executed after steps S501-S504. Also, note that “client” in FIG. 25 refers to a device corresponding to an invoker of the log utilizing API. A user of the log utilizing API may be a developer or a vendor of a server application, for example. Accordingly, the “client” may correspond to a device such as a personal computer (PC), a feature phone, a smart phone, or a tablet terminal of such a user, for example.

First, with respect to case A of FIG. 25, in step S501, the client calls a relevant log utilizing API for case A. The log utilizing part 131b searches for a log from the log storage part 141a based on an argument designated by the called log utilizing API (steps S502 and S503). Note that whether a log utilizing API corresponds to case A or case B may be incorporated in the implementation of the log utilizing API, for example. Next, the log utilizing part 131b generates a return value based on the searched log and transmits the return value to the client (step S504). The return value may be text data in CVS (comma separated values) format or XML (eXtensible Markup Language) format, or display data in HTML (HyperText Markup Language) format, for example.

Next, with respect to case B of FIG. 25, in step S511, the client calls a relevant log utilizing API for case B. In turn, the log utilizing part 131b sends an information acquisition request for information that is specified based on an argument designated by the called log utilizing API to the log analyzing part 131c (step S512). The log analyzing part 131c searches for a log required for generating the information from the log storage part 141a (steps S513 and S514). Next, the log analyzing part 131c analyzes or counts logs found by the search, generates the requested information, and returns the generated information to the log utilizing part 131b (step S515). In turn, the log utilizing part 131b generates a return value based on the information and transmits the generated return value to the client (step S516).

In the following, specific examples of log utilizing APIs are described. As a first specific example of a log utilizing API, a getLogAll method is described below. The interface specification of the getLogAll method is as follows:

getLogAll (application ID, start date/time, end date/time, (tenant ID), (device ID), (device type))

The getLogAll method includes an application ID, a start date/time, and an end date/time as required arguments and includes a tenant ID, a device ID, and a device type as optional arguments. That is, arguments in parentheses (tenant ID, device ID, and device type in the above example) represent arguments that may be designated on an optional basis. Note that the same form of notation is used to represent the interface specifications of other log utilizing APIs described below. The return value of the getLogAll method corresponds to a list of logs specified by the parameters designated by the arguments.

The application ID is an argument corresponding to the “app_id” field of a log. The start date/time and the end date/time are arguments of the “time” field of a log. The tenant ID is an argument corresponding to the “organization_id” field of a log. The device ID is an argument corresponding to the “X-Device-ID” field of a log. The device type is an argument corresponding to the device type of the device 20 stored in the device information storage part 142 in association with the device ID of the device 20, for example. The device type may be classified based on the function and purpose of the device 20, for example. Exemplary values of the device type of the device 20 include “MFP”, “projector”, and “teleconference”. “MFP” represents the device type for the image forming apparatus 20a, “projector” represents the device type for the projector 20b, and “teleconference” represents the device type for the teleconference device 20c.

In response to the call for the getLogAll method, the log utilizing part 131b searches for a log having an “app_id” field value matching the application ID designated as the argument and a “time” field value within the start date/time and the end date/time designated as the arguments from the logs stored in the log storage part 141a. In a case where the tenant ID is designated, the log utilizing part 131b may refine the search to a log having an “organization_id” field value matching the designated tenant ID. Also, in a case where the device type is designated, the search may be refined to a log having a “X-Device-ID” field value that is associated with a device type in the device information storage part 142a matching the device type of the argument.

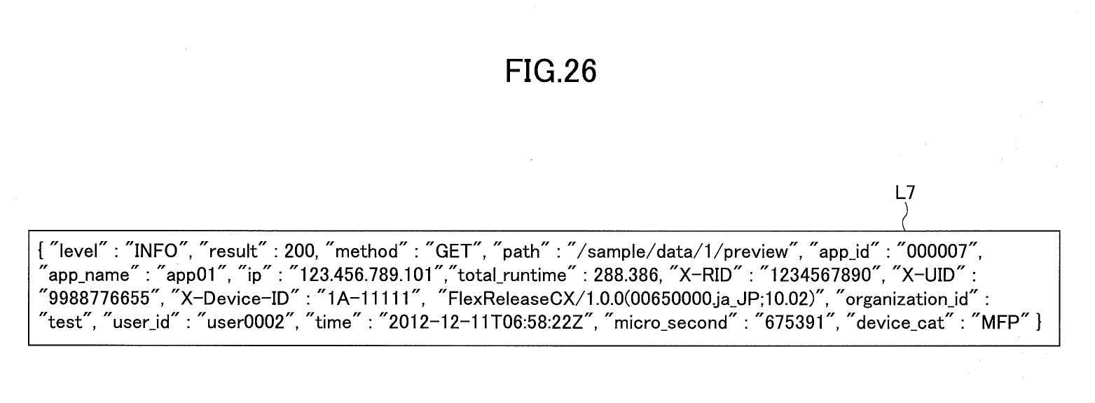

Alternatively, the device type may be included in the logs. FIG. 26 illustrates an exemplary server log L7 including device type information. The server log L7 illustrated in FIG. 26 includes a “device_cat” field at the end. The field value of the “device_cat” field indicates a device type.

The field value of the “device_cat” field of a server log may be acquired from the device information storage part 142b based on the field value of the “X-Device-ID” field of the server log, or the field value of the “device_cat” field may be acquired from a device log. In the case where the field value is acquired from a device log, the device log may be arranged to include a field indicating the device type.

As a second specific example of a log utilizing API, a getClientReport method is described below. The interface specification of the getClientReport method is as follows:

getClientReport (application ID, start date/time, end date/time, (device ID), (device type), (detailed information flag))

The getClientReport method includes an application ID, a start date/time, and an end date/time as required arguments and includes a device ID, a device type, and a detailed information flag as optional arguments. The return value of the getClientReport method corresponds to the number of users of a server application with the designated application ID in each type of device 20 that cooperates with the cloud service system 1 during each unit period (e.g., one month) of a period from the start date/time to the end date/time. The application ID, the start date/time, the end date/time, the device ID, and the device type that may be designated as arguments may be identical to the arguments with the corresponding names in the getLogAll method. The detailed information flag as an optional argument includes the values “true” or “false”. The detailed information flag is described in detail below.

In response to the call for the getClientReport method, the log utilizing part 131b sends an information acquisition request to the log analyzing part 131c for information indicating the number of users of the server application with the designated application ID in each type of device 20 during each unit period of a period from the start date/time to the end date/time.

The log analyzing part 131c searches for a log having an “app_id” field value matching the application ID designated as the argument, a “time” field value within the start date/time and the end date/time designated as the arguments, and a “path” field value representing authentication from the logs stored in the log storage part 141a. That is, the number of users is counted based on the number of authentications performed to enable users to log in. In a case where at least one of the device ID and the device type is designated as an argument, the search may be refined in a manner similar to the refined search implemented in the getLogAll method.

Next, the log analyzing part 131c classifies the logs obtained by the search according to the device type, and with respect to each set of logs classified by device type, counts the number of logs within each unit period of a period defined by the “time” field values of the logs. The log analyzing part 131c returns information indicating the count result to the log utilizing part 131b. The log utilizing part 131b generates a return value based on the returned information and transmits the generated return value to the client.

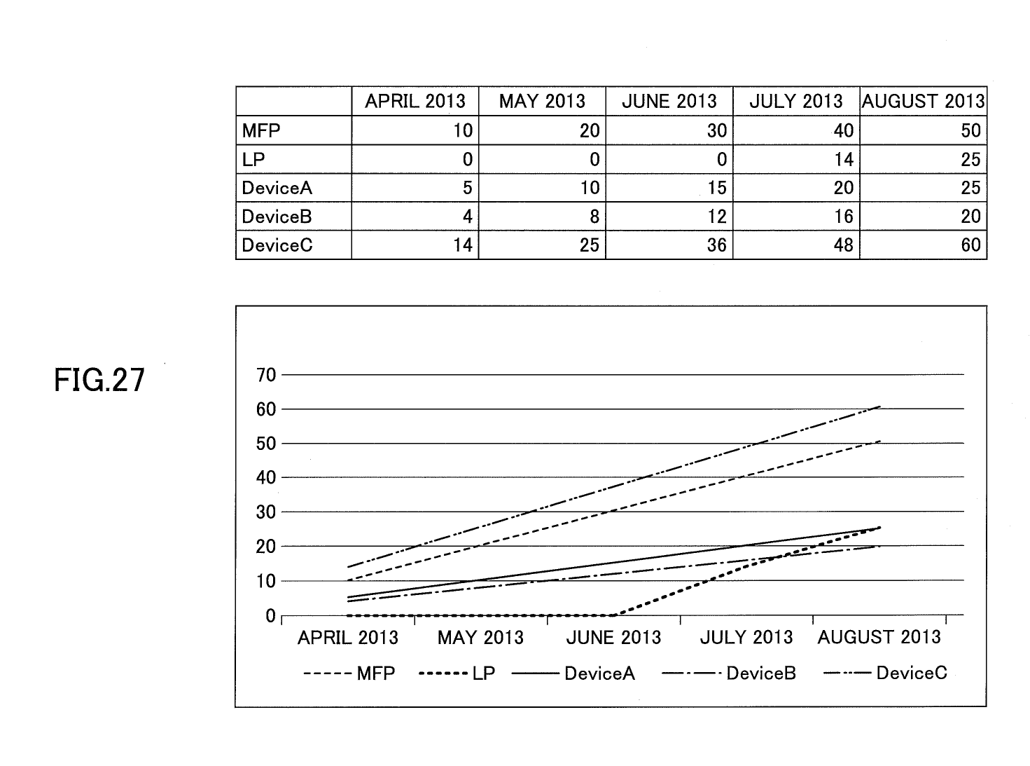

The return value transmitted by the log utilizing part 131b may be HTML data representing a chart or a graph as illustrated in FIG. 27, for example.

FIG. 27 illustrates a first example of a return value of the getClientReport method. FIG. 27 indicates the number of users of each type of device 20 for each month. Note that in the chart and graph illustrated in FIG. 27, “MFP”, “LP”, “Device A”, “Device B”, and “Device C” represent types of the device 20 (device type). By providing a chart and a graph as illustrated in FIG. 27 as a return value, for example, a developer of server applications may easily perceive changes in the number of users of a specific server application in each type of device 20.

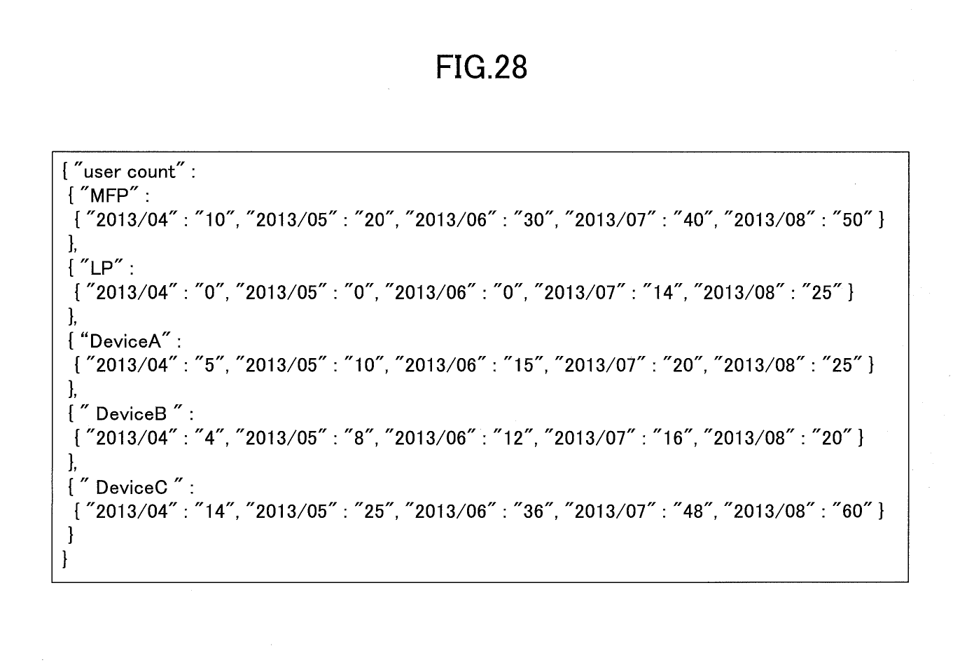

Note that FIG. 27 illustrates an exemplary return value that may be obtained in the case where an application ID, a start date/time (2013/04), and an end date/time (2013/08) are designated as arguments in the getClientReport method. In this case, information generated by the log analyzing part 131c and returned to the log utilizing part 131b may have a configuration as illustrated in FIG. 28, for example.

FIG. 28 illustrates a first example of information indicating a count result of logs searched in connection with implementing the getClientReport method. In FIG. 28, the number of users of each type of device 20 for each month is described in the JSON (Java (registered trademark) Script Object Notation) format.

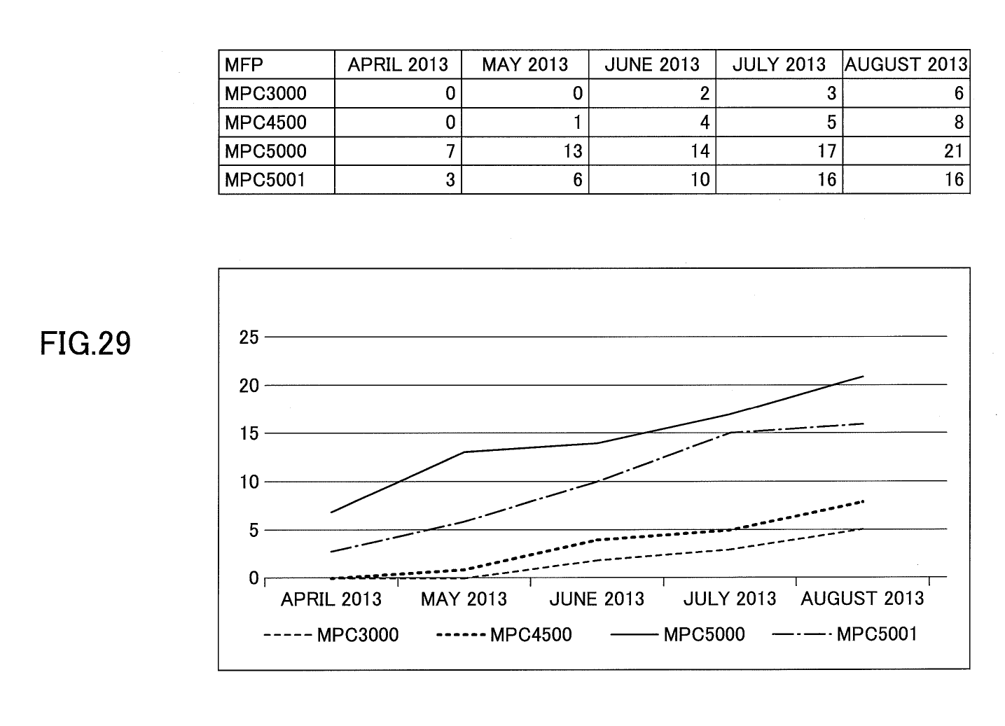

In the case where a device ID is designated as an argument in the call for the getClientReport method, the number of users of the device 20 with the designated device ID for each month may be obtained as the return value. Also, in the case where a device type is designated as an argument, a row or a line of the chart or graph illustrated in FIG. 27 that corresponds to the designated device type may be obtained as the return value. Further, in the case where a device type is designated as an argument and the value “true” of the detailed information flag is designated as an argument, a return value as illustrated in FIG. 29 may be transmitted to the client, for example.

FIG. 29 illustrates a second example of a return value of the getClientReport method. In FIG. 29, the number of users of each model of the device type designated as the argument is indicated for each month. That is, the detailed information flag is an argument for designating whether to further classify the device 20 into different models.

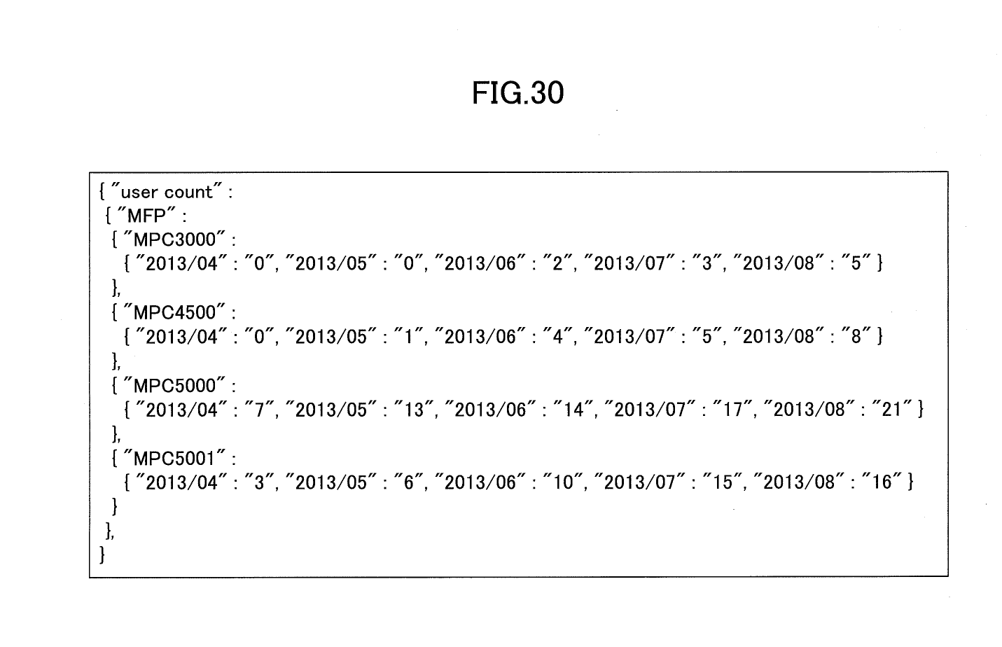

In the case where the return value as illustrated in FIG. 29 is generated, the information generated by the log analyzing part 131c and returned to the log utilizing part 131b may have a configuration as illustrated in FIG. 30, for example.

FIG. 30 illustrates a second example of information indicating a count result of logs searched in connection with implementing the getClientReport method. In FIG. 30, the number of users of each model of the device type “MFP” is indicated for each month.

Note that although the number of users for each unit period of one month is counted in the above examples, the unit period may be changed according to the manner in which the start date/time and the end date/time are designated in the call for the getClientReport method. For example, when the start date/time and the end date/time are specified down to the month, the number of users may be counted on a monthly basis. When the start date/time and the end date/time are specified down to the day of the month, the number of users may be counted on a daily basis. When the start date/time and the end date/time are specified down to the time of the day, the number of users may be counted on an hourly basis. In this way, the unit period used as a basis for counting the number of users may be determined based on the smallest time unit that is designated in the start date/time and end date/time, for example.

As a third specific example of a log utilizing API, a getJobReport method is described below. The interface specification of the getJobReport method is as follows:

getJobReport (application ID, start date/time, end date/time, (delivery destination), (content format))

The getJobReport method includes an application ID, a start date/time, and an end date/time as required arguments and includes a delivery destination and a content format as optional arguments. The return value of the getJobReport method corresponds to the number of times a server application with the designated application ID has executed a job of a cloud scan service within each unit period of a period from the start date/time to the end date/time designated. The application ID, the start date/time, and the end date/time that may be designated as arguments may be identical to the arguments with the corresponding names in the getLogAll method. The delivery destination as an optional argument may take the value “true” or “false”. The content format as an optional argument may take the value “true” or “false”. The value “true” indicates that the number of times a job has been executed is to be counted with respect to each content format of contents that have been delivered.

In response to the call for the getJobReport method, the log utilizing part 131b sends an information acquisition request to the log analyzing part 131c for information indicating the number of times the server application with the designated application ID has executed a job of the cloud scan service within each unit period of a period from the start date/time to the end date/time.

The log analyzing part 131c searches for a log having an “app_id” field value matching the application ID designated as an argument, a “time” field value within the start date/time and the end date/time designated as arguments, and a “path” field value representing delivery, from the logs stored in the log storage part 141a.

Next, with respect to logs obtained from the above search, the log analyzing part 131c counts the number of logs within each unit period based on the “time” field values of the logs. Note that in the case where the value “true” is designated as the argument for the delivery destination, the logs are separately counted with respect to each delivery destination. Also, in the case where the value “true” is designated as the argument for the content format, the logs may be separately counted with respect to each content format of the delivered contents. The log analyzing part 131c returns information indicating the count result to the log utilizing part 131b. The log utilizing part 131b generates a return value based on the returned information and transmits the generated return value to the client.

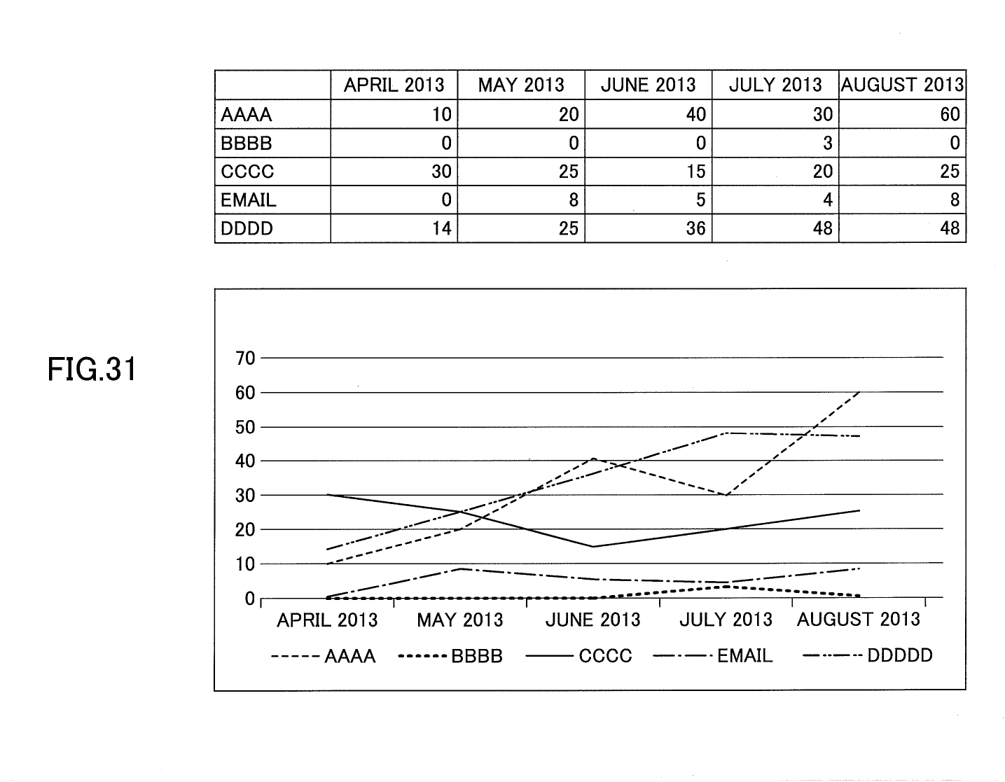

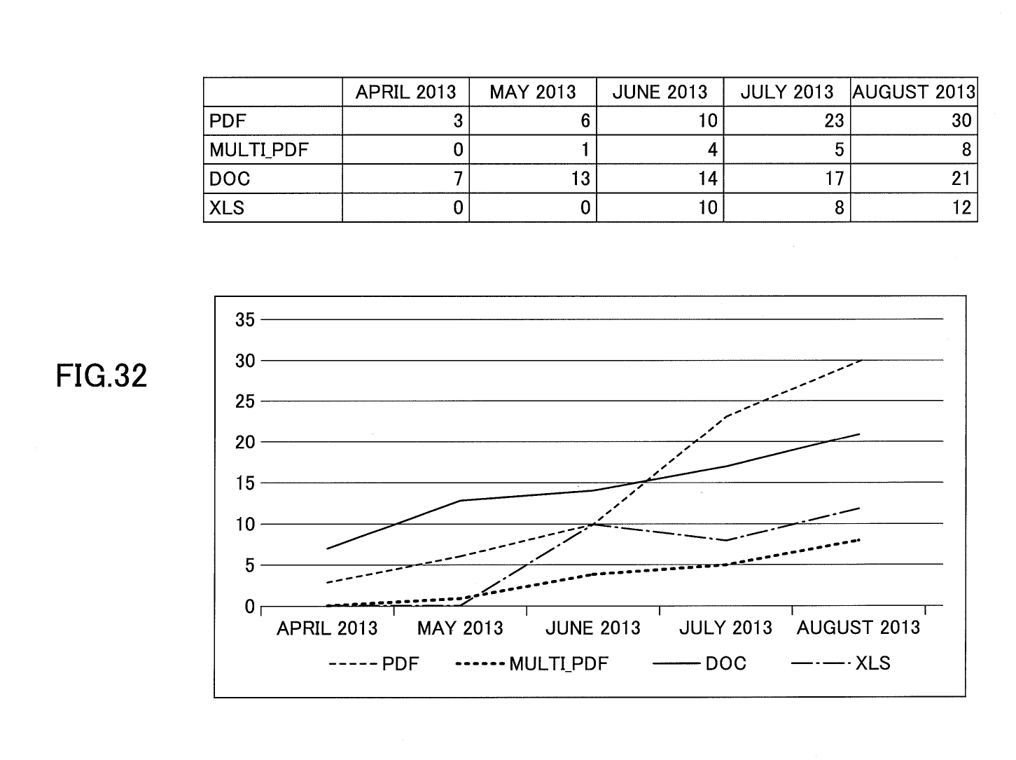

The return value transmitted by the log utilizing part 131b may be HTML data representing a chart or a graph as illustrated in FIG. 31 or 32, for example.

FIG. 31 illustrates a first example of a return value of the getJobReport method. FIG. 31 indicates the number of jobs executed each month with respect to each delivery destination. That is, FIG. 31 illustrates an exemplary return value that may be obtained in the case where the value “true” is designated as the argument for the delivery destination. Note that in the chart and graph illustrated in FIG. 31, “AAAA”, “BBBB”, “CCCC”, and “DDDD” correspond to identification information of delivery destinations. By providing a chart and a graph as illustrated in FIG. 31 as a return value, for example, a developer of server applications may easily perceive changes in the number of jobs executed by a specific server application with respect to each delivery destination.

FIG. 32 illustrates a second example of a return value of the getJobReport method. FIG. 32 indicates the number of jobs executed each month with respect to each content format. That is, FIG. 32 illustrates an exemplary return value that may be obtained in the case where the value “true” is designated as the argument for the content format.

Note that the unit period may be changed according to the manner in which the start date/time and the end date/time are designated as in the getClientReport method.

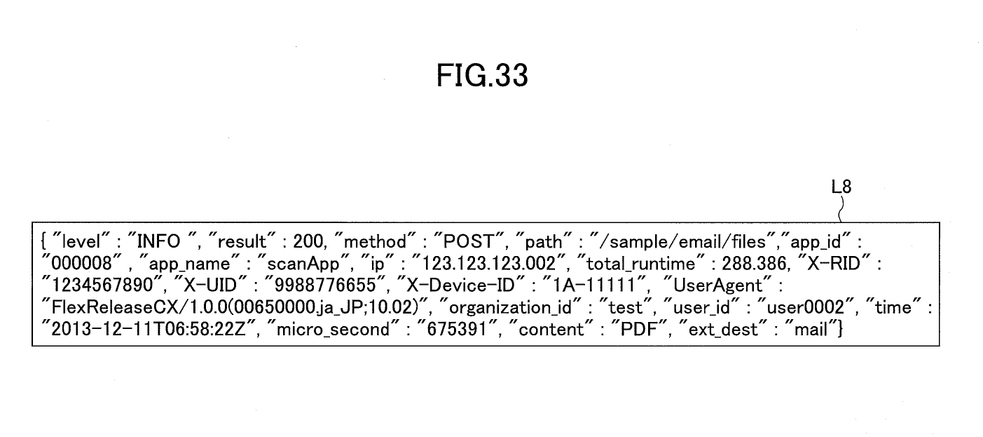

To enable counting of logs based on the delivery destination or the content format as described above, a server log may be arranged to have a configuration as illustrated in FIG. 33, for example.

FIG. 33 illustrates an exemplary server log L8 including information on a delivery destination and a content format. The server log L8 illustrated in FIG. 33 includes a “content” field and an “ext_dest” field at its end. The field value of the “content” field indicates the data format of the content delivered (content format). The field value of the “ext_dest” field represents identification information of the delivery destination. The server log L8 may be recorded by the scan application 120b, for example.

As a fourth specific example of a log utilizing API, a getErrorReport method is described below. The interface specification of the getErrorReport method is as follows:

getErrorReport (application ID, start date/time, end date/time, (error location))

The getErrorReport method includes an application ID, a start date/time, and an end date/time as required arguments and includes an error location as an optional argument. The return value of the getErrorReport method corresponds to information indicating the number of error occurrences related to a process of a server application with the designated application ID within each unit period of a period from the start date/time to the end date/time designated. The application ID, the start date/time, and the end date/time that may be designated as arguments may be identical to the arguments with the corresponding names in the getLogAll method. The error location as an optional argument is an argument for limiting the location of the error occurrence. For example, error occurrences may be distinguished based on the server specified as the error location.

In response to the call for the getErrorReport method, the log utilizing part 131b sends an information acquisition request to the log analyzing part 131c for information indicating the number of error occurrences in the server application with the designated application ID within each unit period of a period from the start date/time to the end date/time.

The log analyzing part 131c searches for a log having an “app_id” field value matching the application ID designated as an argument, a “time” field value within the start date/time and the end date/time designated as arguments, and a “level” field value that is indicated as “ERROR” from the logs stored in the log storage part 141a.

Next, with respect to logs obtained from the above search, the log analyzing part 131c classifies the logs according to the type of error.

For example, if the field value of the “result” field of a log is “401⇄, the log may be classified under authentication error. Further, in some embodiments, the classification result based on the error type may be further classified based on the field value of the “inquiry_code” field (i.e., error code). Based on the “time” field values of the logs, the log analyzing part 131c counts the number of logs within each unit period with respect to each error type and with respect to each error code. The log analyzing part 131c returns information indicating the count result to the log utilizing part 131b. The log utilizing part 131b generates a return value based on the returned information and transmits the generated return value to the client.

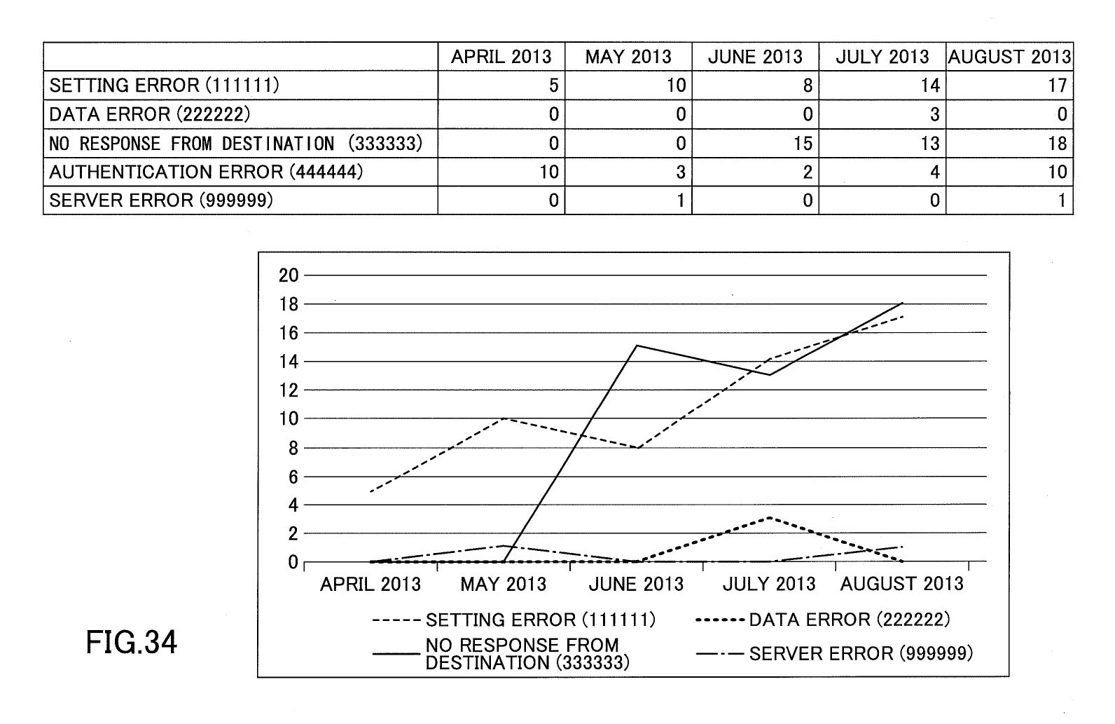

The return value transmitted by the log utilizing part 131b may be HTML data representing a chart or a graph as illustrated in FIG. 34, for example.

FIG. 34 illustrates a first example of a return value of the getErrorReport method. FIG. 34 indicates the number error occurrences each month with respect to each error type (authentication error, data error, no response from destination, server error, etc.) and with respect to each error code. Note that in FIG. 34, the numeric values indicated in parentheses after the descriptions of the error types represent exemplary error codes.

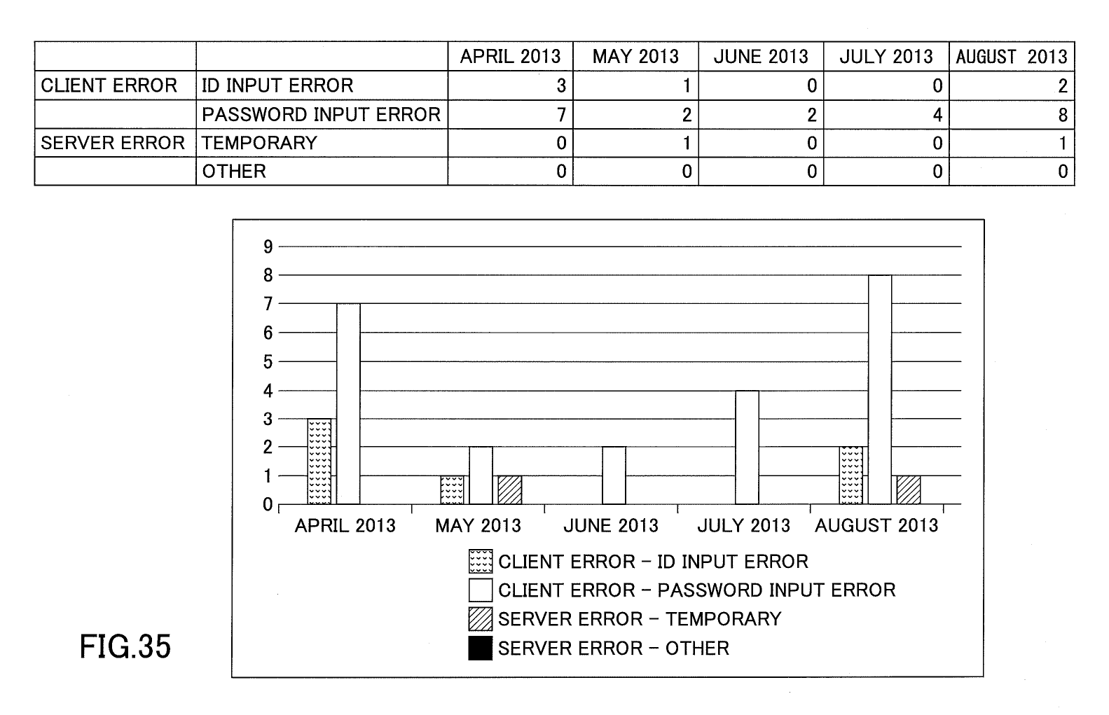

In the case where a value such as “authentication” is designated as an argument for the error location in the call for the getErrorReport method, a return value as illustrated in FIG. 35 may be transmitted to the client, for example.

FIG. 35 illustrates a second example of a return value of the getErrorReport method. In FIG. 35, a breakdown of the authentication error occurrences are indicated for each month. The breakdown of the errors may be based on the error codes or the errors may be divided into server log errors and device log error, for example.

As the error location, values such as “own application” or “content” may be designated as the argument in addition to the value “authentication”. In the case where “own application” is designated, the return value may be a breakdown of errors that have occurred at the application server 121 having the server application with the designated application ID installed therein. In the case where “content” is designated, the return value may be a breakdown of errors that have occurred at the content processing server 133.

As a fifth specific example of a log utilizing API, a getCustomerReport method is described below. The interface specification of the getCustomerReport method is as follows:

getCustomerReport (application ID, start date/time, end date/time, section)

The getCustomerReport method includes an application ID, a start date/time, an end date/time, and a section as required arguments. The return value of the getCustomerReport method corresponds to information relating to the number of users of a server application with the designated application ID within each unit period of a period from the start date/time to the end date/time designated which information is indicated with respect to each attribute designated by the section. The application ID, the start date/time, and the end date/time that may be designated as arguments may be identical to the arguments with the corresponding names in the getLogAll method. The section is an argument designating an attribute based on which users are classified. Exemplary values that may be designated as the argument for the section include “industry” and “employee number”.

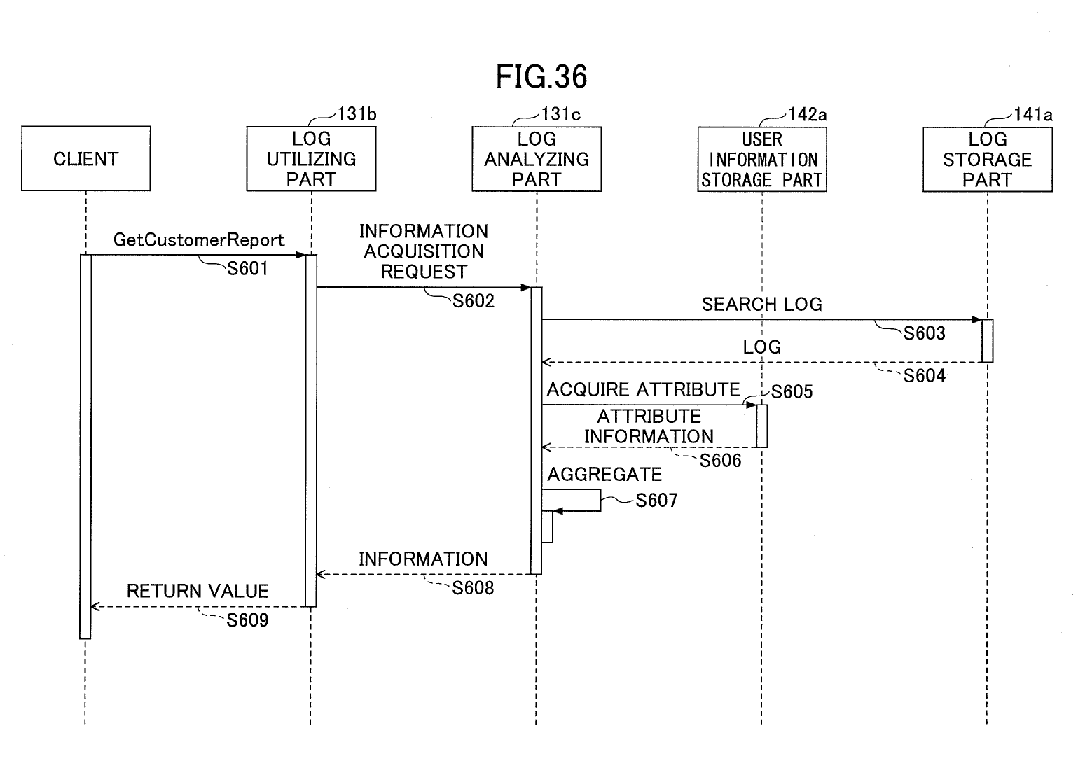

FIG. 36 is a sequence chart illustrating exemplary process steps that may be executed in response to a call for the getCustomerReport method.

In step S601, the log utilizing part 131b receives the call for the getErrorReport method. In response to the call, the log utilizing part 131b sends an information acquisition request to the log analyzing part 131c for information indicating the number of users of the server application with the designated application ID within each unit period of a period from the start date/time to the end date/time and with respect to each attribute designated by the section (step S602).

The log analyzing part 131c searches for a log having an “app_id” field value matching the application ID designated as an argument, a “time” field value within the start date/time and the end date/time designated as arguments, and a “path” field value representing authentication from the logs stored in the log storage part 141a (steps S603 and S604). Next, the log analyzing part 131c classifies logs obtained from the above search based on the field value of the “organization_id” field (i.e., organization ID) of the logs, and acquires, for each of the organization IDS, a corresponding value of the attribute designated by the argument for the section stored in the user information storage part 142a in association with the organization ID (steps S605 and S606). For example, the value “industry” or “employee number” may be acquired in this process step.

Next, the log analyzing part 131c returns information indicating the count/analysis result to the log utilizing part 131b (step S608). The log utilizing part 131b generates a return value based on the returned information and transmits the generated return value to the client (step S609).

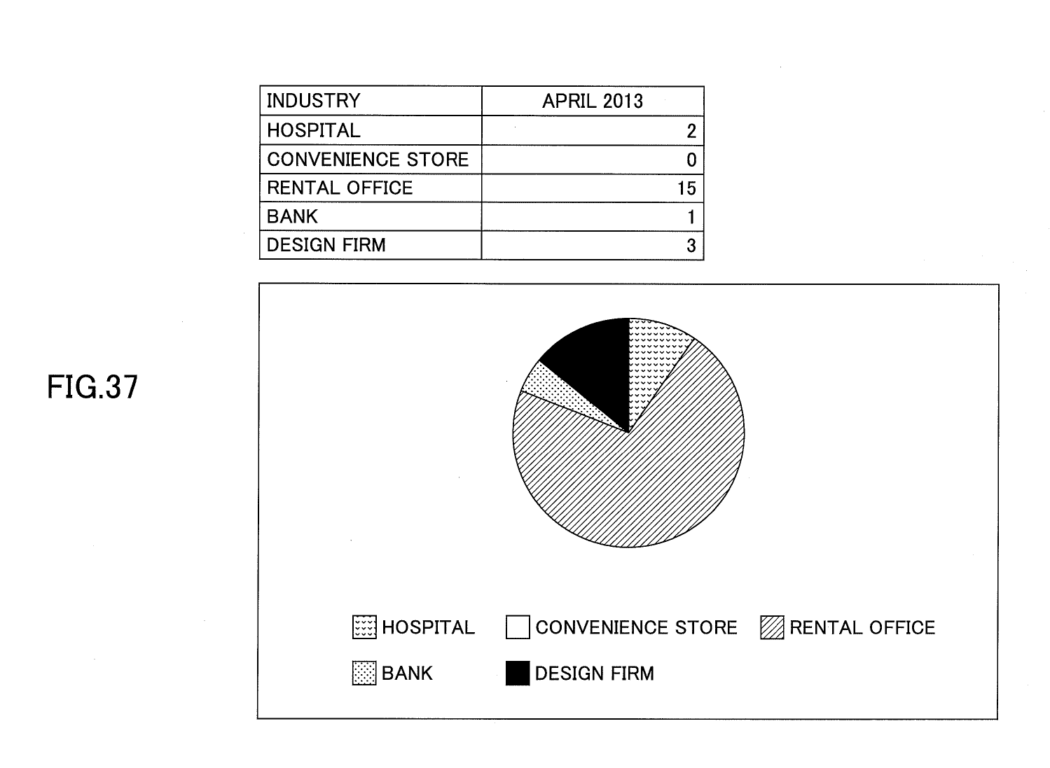

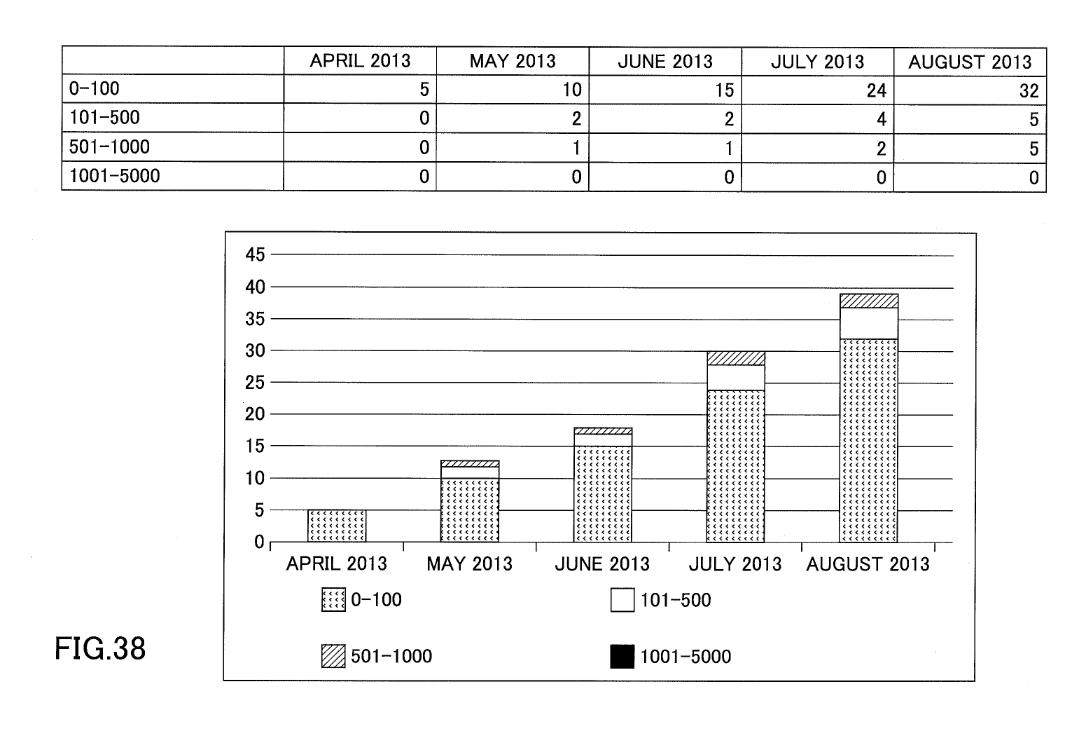

The return value transmitted by the log utilizing part 131b may be HTML data representing a chart or a graph as illustrated in FIG. 37 or 38, for example.

FIG. 37 illustrates a first example of a return value of the getCustomerReport method. FIG. 37 indicates the number of users in each industry during one month. That is, FIG. 37 illustrates an exemplary return value that may be obtained in a case where “2013/04” is designated as the start date/time and the end date/time, and “industry” is designated as the section.

FIG. 38 illustrates a second example of a return value of the getCustomerReport method. In FIG. 38, users (organizations) are categorized based on the number of employees and the number of users in each category for each month is indicated. That is, FIG. 38 illustrates an exemplary return value that may be obtained in a case where “2013/04” is designated as the start date/time, “2013/08” is designated as the end date/time, and “employee number” is designated as the section.

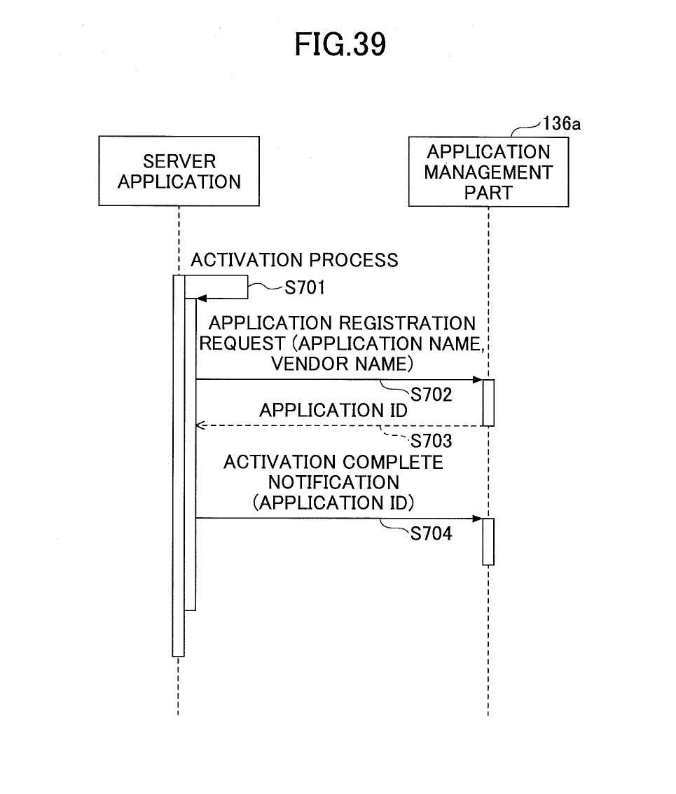

Note that the application ID used as an argument of the above described APIs may be statically assigned to each server application, for example. Alternatively, the application ID may be dynamically assigned to each server application as illustrated in FIG. 39.

FIG. 39 is a sequence chart illustrating exemplary process steps of an application ID assigning process.

During an activation process for activating the application server 121 (step S701), a server application may execute the following process steps.

First, the server application designates attribute information of the server application such as an application name and vendor name of the server application, and transmits a server application registration request to the application management part 136a (step S702). The vendor name refers to identification information of the software vendor that has developed the server application. Note that because the uniqueness of an application name may at least be ensured under the same software vendor, a server application may be unambiguously identified based on a combination of an application name and a vendor name. Note also that other items of information related to the server application may be included in the server application registration request.

In response to the server application registration request, the application management part 136a generates an application ID corresponding to identification information for uniquely identifying each server application and returns the generated application ID to the server application that has sent the server application registration request (step S703). The application management part 136a may store the application ID in association with the attribute information of the server application designated in the server application registration request in the application information storage part 142a, for example.

When the activation process is completed, the server application designates the returned application ID and transmits an activation complete notification to the application management server 136a (step S704). In response to the activation complete notification, the application management part 136a may store information indicating that the server application with this application ID is currently running in a record for this application ID within the application management information storage part 142c, for example.

In a case where the application ID is dynamically assigned, it may be difficult for the client side to acquire the value of the application ID corresponding to the argument of a log utilizing API. Accordingly, in one embodiment, the application ID corresponding to the argument of the log utilizing API may be replaced by the application name or a combination of the application name and the vendor name, for example. In this case, the log utilizing part 131b may refer to the application management information storage part 142c, replace the application ID with the application name or a combination of the application name and vendor name, and execute a process according to the called API, for example.

In another embodiment, an API that returns an application name corresponding to an application ID may be provided as one of the functions provided by the platform API 150.

Note that the interface specifications of the log utilizing APIs described above may be changed or modified as desired. Also, some other log utilizing API may be added as well, for example.

Also, note that the cloud service system 1 described above corresponds to an exemplary embodiment of an information processing system. The Internet gateway 111 corresponds to an exemplary embodiment of a first assigning part and a receiving part. The log storage server 141 corresponds to an exemplary embodiment of a storage part. The application gateway 122, the common service gateway 134, and the database gateway 143 correspond to exemplary embodiments of a second assigning part.

The application server 121, the log management server 131, the authentication server 132, and the content processing server 133 correspond to exemplary embodiments of a process part.

Although the present invention has been described above with reference to certain embodiments, the present invention is not limited to these embodiments, and numerous variations and modifications may be made without departing from the scope of the present invention.

What is claimed is:

1. An information processing system including at least one computer, the information processing system comprising:
a first assigning part that receives from a device a process request including device process identification information identifying a predetermined process unit of the device, and assigns request identification information identifying the process request; and
a storage part that stores the device process identification information and the request identification information in association with each other in connection with a process executed in response to the process request.

2. The information processing system as claimed in claim 1, further comprising:
a second assigning part that assigns process identification information identifying each process unit of a process called by the process request;
wherein the storage part stores, with respect to each process unit, the request identification information assigned to the process request to which the process unit belongs and the process identification information assigned to the process unit in association with each other.

3. The information processing system as claimed in claim 2, further comprising:
a plurality of process parts that are connected to each other via a network and are configured to execute the process unit;
wherein the second assigning part assigns the process identification information to the process unit in response to a process unit execution request issued from one of the plurality of process parts to another one of the plurality of process parts.

4. An information processing system including at least one computer, the information processing system comprising:
a receiving part that receives from a device a process request including request identification information identifying the process request;
a second assigning part that assigns process identification information identifying each process unit of a process called by the process request; and
a storage part that stores, with respect to each process unit, the request identification information and the process identification information assigned to the process unit in association with each other.

5. The information processing system as claimed in claim 4, further comprising:
a plurality of process parts that are connected to each other via a network and are configured to execute the process unit;
wherein each of the plurality of process parts correspond to the second assigning part.
